(19) United States
(12) Patent Application Publication
(10) Pub. No.: US 2026/0166733 A1
(43) Pub. Date: Jun. 18, 2026

(54) ROBOT SYSTEM WITH SUPPLEMENTARY METROLOGY POSITION DETERMINATION SYSTEM

(71) Applicant: Mitutoyo Corporation, Kanagawa-ken (JP)

(72) Inventor: Michael NAHUM, Seattle, WA (US)

(21) Appl. No.: 18/984,218

(22) Filed: Dec. 17, 2024

(51) Int. Cl. B25J 9/16; B25J 13/08; B25J 18/04; B25J 19/02

(52) U.S. Cl. CPC B25J 9/1664; B25J 9/1653; B25J 13/088; B25J 18/04; B25J 19/023

(57) ABSTRACT

A supplementary metrology position determination system is provided for use with a robot. The robot includes a movable arm configuration and a motion control system configured to control an end tool position with a robot accuracy (i.e., based on sensors included in the robot). The supplementary system includes cameras and scales, each of which is attached to the movable arm configuration. Cameras are coupled to arm portions (e.g., at or near distal ends of the arm portions) such that the cameras rotate around scales (e.g., as the arm portions rotate around rotary axes). The scales may be at least partially cylindrical. The cameras are operated to acquire images of the scales for determining angular positions and/or bending and/or twisting of the arm portions of the robot. Such information may be utilized to achieve higher accuracy (e.g., for measurement operations and/or control of the robot, etc.).

### BACKGROUND

### Technical Field

This disclosure relates to robot systems, and more particularly to systems for determining coordinates of an end tool position of a robot.

### Description of the Related Art

Robotic systems are increasingly utilized for manufacturing and other processes. Various types of robots that may be utilized include articulated robots, selective compliance articulated robot arm (SCARA) robots, cartesian robots, cylindrical robots, spherical robots, etc. As one example of components that may be included in a robot, a SCARA robot system (e.g., which may be a type of articulated robot system) may typically have a base, with a first arm portion rotationally coupled to the base, and a second arm portion rotationally coupled to an end of the first arm portion. In various configurations, an end tool may be coupled to an end of the second arm portion (e.g., for performing certain work and/or inspection operations). Such systems may include position sensors (e.g., rotary encoders) utilized for determining/controlling the positioning of the arm portions and correspondingly the positioning of the end tool. In various implementations, such systems may have a positioning accuracy of approximately 100 microns, as limited by certain factors (e.g., the rotary encoder performance in combination with the mechanical stability of the robot system, etc.).

U.S. Pat. No. 4,725,965, which is hereby incorporated herein by reference in its entirety, discloses certain calibration techniques for improving the accuracy of a SCARA system. As described in the '965 patent, a technique is provided for calibrating a SCARA type robot comprising a first rotatable arm portion and a second rotatable arm portion which carries an end tool. The calibration technique is in relation to the fact that the SCARA robot may be controlled using a kinematic model, which, when accurate, allows the arm portions to be placed in both a first and second angular configuration at which the end tool carried by the second arm portion remains at the same position. To calibrate the kinematic model, the arm portions are placed in a first configuration to locate the end tool above a fixed datum point. Then, the arm portions are placed in a second angular configuration to nominally locate the end tool again in registration with the datum point. The error in the kinematic model is computed from the shift in the position of the end tool from the datum point when the arm portions are switched from the first to the second angular configuration. The kinematic model is then compensated in accordance with the computed error. The steps are repeated until the error reaches zero, at which time the kinematic model of the SCARA robot is considered to be calibrated.

As further described in the '965 patent, the calibration technique may include the use of certain cameras. For example, in one implementation, the datum point may be the center of the viewing area of a stationary television camera (i.e., located on the ground below the end tool), and the output signal of the camera may be processed to determine the shift in the position of the end tool from the center of the viewing area of the camera when the links are switched from the first to the second configuration. In another implementation, the second arm portion may carry a camera, and the technique may begin by placing the arm portions in a first angular configuration, at which a second predetermined interior angle is measured between the arm portions, to center the camera carried by the second arm portion directly above a fixed datum point. The arm portions are then placed in a second angular configuration, at which an interior angle, equal to the second predetermined interior angle, is measured between the arm portions, to nominally center the camera again above the datum point. The output signal of the camera is then processed to determine the shift in the position of the datum point, as seen by the camera, upon switching the arm portions from the first to the second angular configuration. The error in the known position of the camera is then determined in accordance with the shift in the position of the datum point as seen by the camera. The steps are then repeated as part of the calibration process until the error approaches zero.

While techniques such as those described in the '965 patent may be utilized for calibrating a robot system, in certain applications it may be less desirable to utilize such techniques (e.g., which may require significant time and/or may not provide a desired level of accuracy for all possible orientations of a robot during certain operations, etc.) A robot system that can provide improvements with regard to such issues (e.g., for increasing the reliability, repeatability, speed, etc. of the position determination during workpiece measurements and other processes) would be desirable.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A supplementary metrology position determination system is provided for use in conjunction with a robot as part of a robot system. The robot (e.g., a SCARA robot, etc.) includes a movable arm configuration and a motion control system. The movable arm configuration includes a first arm portion, a second arm portion, and an end tool mounting configuration for mounting an end tool. The first arm portion is mounted to a first rotary joint at a proximal end of the first arm portion. The first rotary joint has a first rotary axis. The first arm portion has a second rotary joint located at a distal end of the first arm portion. The second rotary joint has a second rotary axis. The second arm portion is mounted to the second rotary joint at a proximal end of the second arm portion, such that the second arm portion rotates about the second rotary joint. The end tool mounting configuration is located proximate to a distal end of the movable arm configuration. The motion control system is configured to control an end tool position of the end tool with a level of accuracy defined as a robot accuracy, based at least in part on sensing and controlling the angular positions of the first and second arm portions about the first and second rotary joints, respectively, using rotary sensors included in the robot.

The supplementary metrology position determination system includes first and second scales, a first camera, a second camera, and a metrology processing portion. The first and second scales are coupled to the movable arm configuration at first and second scale coupling locations, respectively. Each scale includes a plurality of respective imageable features (e.g., distributed along a rotary measurement axis direction). The first camera is coupled to the first arm portion such that the first camera is configured to rotate around the first scale and a field of view of the first camera is configured to move along a first rotary measurement axis direction on the first scale as the first arm portion is rotated around the first rotary joint, and for which a bending of the first arm portion causes a movement of the field of view of the first camera along a direction that is transverse to the first rotary measurement axis direction on the first scale. The second camera is for acquiring an image of the second scale at the image acquisition time. The second camera is coupled to the second arm portion such that the second camera is configured to rotate around the second scale and a field of view of the second camera is configured to move along a second rotary measurement axis direction on the second scale as the second arm portion is rotated around the second rotary joint, and for which a bending of the second arm portion causes a movement of the field of view of the second camera along a direction that is transverse to the second rotary measurement axis direction on the second scale.

Also disclosed is a method for operating a supplementary metrology position determination system that is utilized with a robot. The method may be summarized as including: operating the first camera to acquire a first image of the first scale at a first image acquisition time, wherein the first camera is coupled to the first arm portion such that the first camera rotates around the first scale and a field of view of the first camera moves along a first rotary measurement axis direction on the first scale as the first arm portion is rotated around the first rotary joint, and for which a bending of the first arm portion causes a movement of the field of view of the first camera along a direction that is transverse to the first rotary measurement axis direction on the first scale; and operating the second camera to acquire a first image of the second scale at the first image acquisition time, wherein the second camera is coupled to the second arm portion such that the second camera rotates around the second scale and a field of view of the second camera moves along a second rotary measurement axis direction on the second scale as the second arm portion is rotated around the second rotary joint, and for which a bending of the second arm portion causes a movement of the field of view of the second camera along a direction that is transverse to the second rotary measurement axis direction on the second scale.

Also disclosed is an implementation in which the supplementary metrology position determination system is provided for use with a robot that includes a movable arm configuration with an end tool mounting configuration for mounting an end tool and a motion control system configured to control an end tool position of the end tool.

The supplementary metrology position determination system described herein may be added to an existing robot that already includes a measurement system (e.g., see block 140 of FIG. 1) with rotary encoders included in each of the robot rotary joints, which is able to provide a measurement/determination of where the end tool position is at the end of the robot arms, and which is referred to herein as a “robot accuracy”, and for which the included encoders sometimes have limited/less accuracy than might be desired.

The present invention is intended to provide a supplementary metrology system (e.g., that may be attached to an existing robot, with the additional cameras and scales attached to the robot arms), and which can provide improved accuracy for determining the end tool position at the end of the robot (i.e., at the end of the robot arms). More specifically, the encoders in the existing robot may only measure the rotations of the rotary joints, and for which the robot system/model may assume all of the joints rotate perfectly and that the arms stay perfectly straight. For any number of reasons, this may not be the case (e.g., the arms may be heavy which may cause bending/twisting of the arms/joints, the end tool placed at the end of the arm may be heavy, the joints may not rotate perfectly, etc.) for which there may “wobble” or “slop” in the movement of the joints (or other motion transverse to the expected joint/rotary axis), or some amount of bending/twisting of the arms, etc. The present invention adds cameras and scales attached to the robot, and for which the scales are monitored/imaged by the cameras in order to detect both the usual rotary motions as well as the undesirable motions (e.g., bending, twisting, wobble, slop, etc.), and for which the determinations of the amount of the undesirable motions can be added to the calculation/model for determining the end tool position of the end tool at the end of the robot, with a better accuracy than if only the rotary encoders of the robot were utilized. In some implementations, such techniques may enable accuracies in the range of 10 microns or better to be achieved (e.g., as opposed to a 100 micron accuracy of certain prior robot systems). Such improved accuracy may be particularly desirable for certain applications (e.g., measurements of workpieces, precision drilling of holes in workpieces, precision manipulation and placement of very small workpieces or other elements, etc.).

### BRIEF DESCRIPTION OF THE SEVERAL VIEWS OF THE DRAWINGS

FIG. 1 is a block diagram of a first exemplary implementation of a robot system including an articulated robot and a supplementary metrology position determination system;

FIG. 2 is an isometric diagram of a second exemplary implementation of a robot system similar to the robot system of FIG. 1;

FIG. 3 is a bottom view of a portion of a robot system;

FIGS. 4A and 4B are side views of a portion of a robot system;

FIG. 5 is an isometric diagram of a first exemplary implementation of an incremental scale;

FIG. 6 is an isometric diagram of a second exemplary implementation of an incremental scale;

FIG. 7 is an isometric diagram of an exemplary implementation of an absolute scale;

FIGS. 8A and 8B are flow diagrams illustrating exemplary implementations of routines for operating a robot system including an articulated robot and a supplementary metrology position determination system;

FIG. 9 is a flow diagram illustrating an exemplary implementation of a routine for determining an end tool position in which position sensors of a robot may be utilized during a first portion of a movement timing and a supplementary metrology position determination system may be utilized during a second portion of a movement timing; and

FIG. 10 is a flow diagram illustrating an exemplary implementation of a routine for operating a supplementary metrology position determination system that is utilized with a robot.

### DETAILED DESCRIPTION

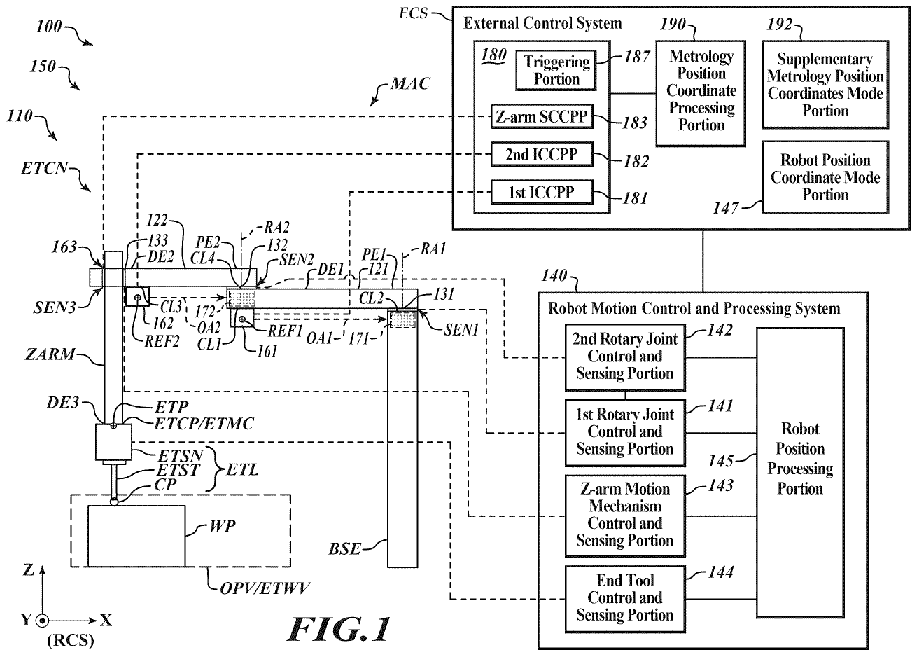

FIG. 1 is a block diagram of a first exemplary implementation of a robot system 100 including an articulated robot 110 and a supplementary metrology position determination system 150. The articulated robot 110 includes a movable arm configuration MAC and a robot motion control and processing system 140. In the example of FIG. 1, the movable arm configuration MAC includes first and second arm portions 121 and 122, first and second rotary joints 131 and 132 (e.g., included as part of first and second motion mechanisms), position sensors SEN1 and SEN2, and an end tool configuration ETCN. The first arm portion 121 is mounted to the first rotary joint 131 at a proximal end PE1 of the first arm portion 121. The first rotary joint 131 (e.g., located at an upper end of a supporting base portion BSE) has a rotary axis RA1 aligned along a z axis direction such that the first arm portion 121 is intended to nominally move about the first rotary joint 131 in an x-y plane that is perpendicular to the z axis (e.g., of a robot coordinate system). The second rotary joint 132 is located at a distal end DE1 of the first arm portion 121. The second rotary joint 132 has its rotary axis RA2 nominally aligned along the z axis direction. The second arm portion 122 is mounted to the second rotary joint 132 at a proximal end PE2 of the second arm portion 122, such that the second arm portion 122 is intended to nominally move about the second rotary joint 132 in an x-y plane that is nominally perpendicular to the z axis. In various implementations, the position sensors SEN1 and SEN2 (e.g., rotary encoders) may be utilized for determining the angular positions (i.e., in the x-y plane) of the first and second arm portions 121 and 122 about the first and second rotary joints 131 and 132, respectively.

In various implementations, the end tool configuration ETCN may include a Z-motion mechanism 133 (e.g., included as part of a third motion mechanism), a Z-arm portion ZARM (e.g., designated as a third arm portion), a position sensor SEN3 and an end tool coupling portion ETCP (e.g., included as part of an end tool mounting configuration ETMC) which couples to an end tool ETL. In various implementations, the end tool ETL may include an end tool sensing portion ETSN and an end tool stylus ETST with a contact point CP (e.g., for contacting a surface of a workpiece WP). The Z-motion mechanism 133 is located proximate to the distal end DE2 of the second arm portion 122. The Z-motion mechanism 133 (e.g., a linear actuator) is configured to move the Z-arm portion ZARM up and down in the z axis direction. In some implementations, the Z-arm portion ZARM may also be configured to rotate about an axis parallel to the z axis direction. In any case, the end tool ETL is coupled at the end tool coupling portion ETCP, and has a corresponding end tool position ETP with corresponding coordinates (e.g., x, y and z coordinates). In various implementations, the end tool position ETP may correspond to, or be proximate to, the distal end DE3 of the Z-arm portion ZARM (e.g., at or proximate to the end tool coupling portion ETCP).

The motion control system 140 of the robot is configured to control the end tool position ETP of the end tool ETL with a level of accuracy defined as a robot accuracy. More specifically, the motion control system 140 is generally configured to control the coordinates of the end tool position ETP with the robot accuracy based at least in part on sensing and controlling the angular positions (i.e., in the x-y plane) of the first and second arm portions 121 and 122 about the first and second rotary joints 131 and 132, respectively, using the position sensors SEN1 and SEN2. In various implementations, the motion control and processing system 140 may include first and second rotary joint control and sensing portions 141 and 142 that may receive signals from the position sensors SEN1 and SEN2, respectively, for sensing the angular positions of the first and second arm portions 121 and 122, and/or may provide control signals (e.g., to motors, etc.) in the first and second rotary joints 131 and 132 for rotating the first and second arm portions 121 and 122.

In general, the robot accuracy is related to certain assumptions about the movements of the robot (e.g., as may be related to a model, such as a kinematic and/or geometric model, etc., and/or corresponding calculations that are utilized for determining the end tool position). For example, in accordance with the robot accuracy, the determination of the end tool position may generally be based on the known lengths of the first and second arm portions 121 and 122, which are assumed to be level and straight and to not bend or twist, and the rotations about the first and second rotary joints 131 and 132, which are assumed to be precise, with centered rotary motion around each respective rotary axis of each rotary joint. However, in some instances certain arm portions may bend or twist, and/or some rotary joint motion may be transverse to the respective rotary axis. For example, there may be possible vertical displacement or sag at the distal ends DE1 and DE2 of the first and second arm portions 121 and 122, respectively (e.g., due to the weight and/or different orientations of the arm portions and/or end tool configuration, etc.) and/or there may be undesirable motion during the rotation about the first and/or second rotary joints 131 and 132 (e.g., motion transverse to the respective rotary axis). As will be described in more detail below, in accordance with principles disclosed herein, a higher accuracy for a determination of an end tool position or other robot motion/positioning may be achieved by utilizing a supplementary metrology position determination system that is able to determine, measure, and/or otherwise account for such undesirable motions (e.g., bending or twisting of arm portions, rotary joint motion transverse to a rotary axis, etc.). It will be appreciated that even small improvements in accuracy may be highly desirable for certain applications (e.g., for measurement and control operations of a robot, such as measurements of workpieces, precision drilling of holes in workpieces, etc.).

The motion control system 140 of the robot is also generally configured to control the z coordinate of the end tool position ETP with the robot accuracy based at least in part on sensing and controlling the linear position (i.e., along the z axis) of the Z-arm portion ZARM using the Z-motion mechanism 133 and the position sensor SEN3. In various implementations, the motion control and processing system 140 may include a Z-arm motion mechanism control and sensing portion 143 that may receive signals from the position sensor SEN3 for sensing the linear position of the Z-arm portion ZARM, and/or may provide control signals to the Z-motion mechanism 133 (e.g., a linear actuator) to control the z position of the Z-arm portion ZARM. As will be described in more detail below, in some implementations the supplementary metrology position determination system 150 may include a corresponding position sensor 163, which may provide similar information and may operate similarly as the position sensor SEN3 (e.g., or which may operate differently and/or may be a higher accuracy sensor than the position sensor SEN3). In some implementations, the supplementary metrology position determination system 150 may not include a corresponding position sensor 163 and may instead utilize the sensed data from the position sensor SEN3 which is sent to the supplementary metrology position determination system 150. In some implementations, the supplementary metrology position determination system 150 may provide other sensed position information (e.g., regarding relative positions of the arm portions 121 and 122 and/or rotary joints 131 and 132) to the motion control and processing system 140 for more accurately determining an end tool position.

The motion control and processing system 140 and/or supplementary metrology position determination system 150 may also receive signals from the end tool sensing portion ETSN. In various implementations, the end tool sensing portion ETSN may include circuitry and/or configurations related to the operations of the end tool ETL for sensing a workpiece WP. As will be described in more detail below, in various implementations the end tool ETL (e.g., a touch probe, a scanning probe, a camera, etc.) may be utilized for contacting or otherwise sensing surface locations/positions/points on a workpiece WP, for which various corresponding signals may be received, determined and/or processed by the end tool sensing portion ETSN which may provide corresponding signals to the motion control and processing system 140 and/or supplementary metrology position determination system 150. In various implementations, the motion control and processing system 140 and/or supplementary metrology position determination system 150 may include an end tool control and sensing portion 144 that may provide control signals to and/or receive sensing signals from the end tool sensing portion ETSN. In various implementations, the end tool control and sensing portion 144 and the end tool sensing portion ETSN may be merged and/or indistinguishable. In various implementations, the first and second rotary joint control and sensing portions 141 and 142, the Z-motion mechanism control and sensing portion 143, and the end tool control and sensing portion 144 may all provide outputs to and/or receive control signals from a robot position processing portion 145 which may control and/or determine the overall positioning of the articulated robot 110 and corresponding end tool position ETP as part of the robot motion control and processing system 140. In various implementations, the articulated robot 110 may have a designated operable work volume OPV, which may also or alternatively be designated as an end tool working volume ETWV, in which at least a portion of the end tool (e.g., the contact point CP) may be moved (e.g., for measuring/inspecting a workpiece, etc.).

In the configuration of FIG. 1, the robot 110 is configured to move the movable arm configuration MAC so as to move at least a portion of the end tool ETL that is mounted to the end tool mounting configuration ETMC along at least two dimensions in the end tool working volume ETWV. The motion control system 140 is configured to control the end tool position ETP with a level of accuracy defined as the robot accuracy, based at least in part on sensing and controlling the position of the movable arm configuration MAC (e.g., using one or more position sensors included in the robot 110).

In various implementations, the supplementary metrology position determination system 150 may be included with or otherwise added to an articulated robot 110 (e.g., as part of a retrofit configuration for being added to an existing articulated robot 110, etc.) In general, the supplementary metrology position determination system 150 may be utilized to provide an improved level of accuracy for the determination of the end tool position ETP. More specifically, as will be described in more detail below, the supplementary metrology position determination system 150 may be utilized to determine relative positions (e.g., in accordance with images of scales which indicate angular orientations, bending, and/or twisting of arm portions of the robot) that are indicative of, and may be utilized to determine, the metrology position coordinates of the end tool position ETP, with an accuracy level that is better than the robot accuracy.

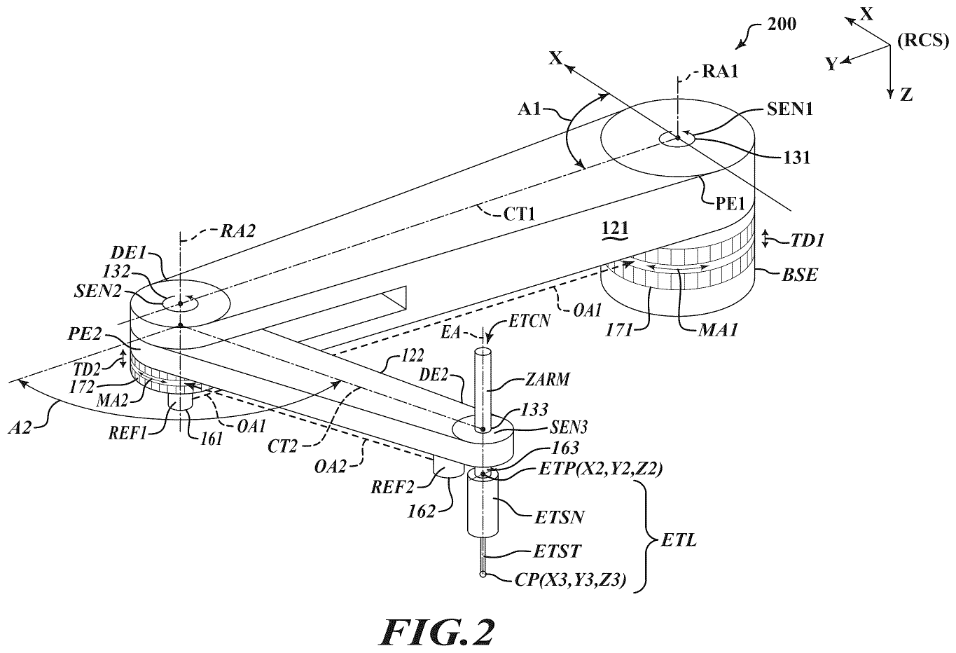

As illustrated in FIG. 1, the supplementary metrology position determination system 150 may include cameras 161 and 162, a sensor 163, scales 171 and 172, and a metrology position coordinate processing portion 190. As illustrated in FIGS. 1 and 2 (i.e., for which the configuration of FIG. 2 will be described in more detail below), the cameras/scales are arranged as two camera/scale sets, including the cameras 161 and 162, each directed at a corresponding scale 171 and 172. The scales 171 and 172 are coupled to the movable arm configuration MAC of the robot 110. In various implementations, each of the cameras 161 and 162 and scales 171 and 172 is coupled to the robot 110 at a respective coupling location CL1-CL4. More specifically, the camera 161 is coupled to the arm portion 121 at a camera coupling location CL1 (e.g., at or proximate to a distal end DE1 of the arm portion 121). The scale 171 is coupled to the base portion BSE at a scale coupling location CL2. The camera 162 is coupled to the second arm portion 122 at a camera coupling location CL3 (e.g., proximate or near to a distal end DE2 of the arm portion 122). The scale 172 is coupled to the first arm portion 121 at a scale coupling location CL4 (e.g., at or proximate to a distal end DE1 of the arm portion 121).

In various implementations, the coupling of each of the various components may be achieved utilizing one or more coupling components, elements, mechanisms and/or techniques (e.g., such as fastening elements, bolts, clamps, adhesive glue, etc.) In various implementations, the scales 171 and 172 may be included on a substrate that is either flexible (e.g., a sticker) and/or at least partially cylindrically shaped, with an adhesive backing or other attachment mechanism such that the scales may be wrapped around and/or adhered to the movable arm configuration at the respective scale coupling locations CL2 and CL4 (e.g., on the base portion BSE and the distal end DE1 of the arm portion 121).

As illustrated in FIGS. 1 and 2 (i.e., for which the configuration of FIG. 2 will be described in more detail below), in various implementations the camera 161 defines a reference position REF1 and an optical axis OA1 of the camera 161 is aligned with a portion (e.g., center portion) of the scale 171, and features of the scale 171 are imageable by the camera 161. In accordance with this configuration, as the arm portion 121 rotates around the rotary axis RA1, the camera 161 (e.g., as coupled at or near the distal end DE1 of the arm portion 121) rotates around the scale 171. The camera 162 defines a reference position REF2 and an optical axis OA2 of the camera 162 is aligned with a portion (e.g., center portion) of the scale 172, and features of the scale 172 are imageable by the camera 162. In accordance with this configuration, as the arm portion 122 rotates around the rotary axis RA2, the camera 162 (e.g., as coupled proximate to or near the distal end DE2 of the arm portion 122) rotates around the scale 172.

Each of the cameras 161 and 162 is controlled by and provides image signals to a respective imaging configuration control and processing portion (ICCPP) 181 and 182. A triggering portion 187 may in some instances coordinate the triggering of the cameras 161 and 162 to obtain an image at the same time (e.g., as corresponding to a position of the robot 110 at a particular moment in time for determining the end tool position at the end of the robot 110 at that time). In implementations where a position sensor 163 is included (e.g., for sensing the position of the Z-arm portion ZARM), such may be controlled by and provide position signals to a sensing configuration control and processing portion (SCCPP) 183, for which collection and/or recording of position data may in some implementations be triggered by the signal from the triggering portion 187.

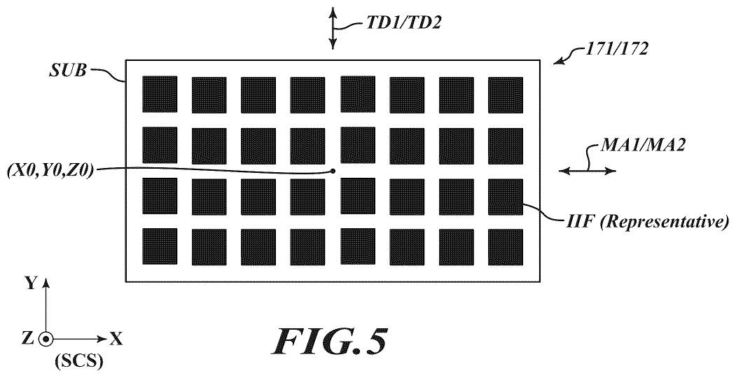

In various implementations, each of the scales 171 and 172 comprises a substrate SUB and a plurality of respective imageable features that are distributed on the substrate SUB. The respective imageable features are located at respective known local coordinates (e.g., at x and y scale coordinates and/or other scale coordinates) on each scale (e.g., for which in various implementations each scale may be at least partially cylindrically shaped, such as wrapped around the base portion BSE and/or the end of the arm portion 122, etc.). In various implementations, each scale may be an incremental or absolute scale, as will be described in more detail below with respect to FIGS. 5-7.

In various implementations, the triggering portion 187 and/or the metrology position coordinate processing portion 190 may be included as part of an external control system ECS (e.g., as part of an external computer, etc.) The triggering portion 187 may be included as part of an imaging and sensing configuration control and processing portion 180. In various implementations, the triggering portion 187 is configured to input at least one input signal that is related to the end tool position ETP and to determine the timing of a first trigger signal based on the at least one input signal, and to output the first trigger signal to the cameras 161 and 162 and the position sensor 163. In various implementations, each of the cameras 161 and 162 is configured to acquire a digital image of the corresponding scale 171 and 172, respectively, at an image acquisition time in response to receiving the first trigger signal. In various implementations, the metrology position coordinate processing portion 190 is configured to input the acquired images and to identify at least one respective imageable feature included in each acquired image of the scales and a related respective known scale coordinate location. In various implementations, the external control system ECS may also include a standard robot position coordinates mode portion 147 and a supplementary metrology position coordinates mode portion 192, for implementing corresponding modes, as will be described in more detail below.

In various implementations, each imaging configuration control and processing portion 181 and 182 may include a component (e.g., a subcircuit, routine, etc.) that activates an image integration of the corresponding camera 161 and 162 periodically (e.g., at a set timing interval) for which the first trigger signal may activate a strobe light timing (e.g., for which each camera 161 and 162 may include a strobe light) or other mechanism to effectively freeze motion and correspondingly determine an exposure within the integration period. In such implementations, if no first trigger signal is received during the integration period, a resulting image may be discarded, wherein if a first trigger signal is received during the integration period, the resulting image may be saved and/or otherwise processed/analyzed to determine a relative position, as will be described in more detail below.

In various implementations, different types of end tools ETL may provide different types of outputs that may be utilized with respect to the triggering portion 187. For example, in an implementation where the end tool ETL is a touch probe that is used for measuring a workpiece and that outputs a touch signal when it touches the workpiece, the triggering portion 187 may be configured to input that touch signal, or a signal derived therefrom, as the at least one input signal that the timing of a first trigger signal is determined based on. As another example, in an implementation where the end tool ETL is a scanning probe that is used for measuring a workpiece and that provides respective workpiece measurement sample data corresponding to a respective sample timing signal, the triggering portion 187 may be configured to input that respective sample timing signal, or a signal derived therefrom, as the at least one input signal. As another example, in an implementation where the end tool ETL is a camera that is used to provide a respective workpiece measurement image corresponding to a respective workpiece image acquisition signal, the triggering portion 187 may be configured to input that workpiece image acquisition signal, or a signal derived therefrom, as the at least one input signal.

In the example implementation of FIG. 1, the supplementary metrology position determination system 150 is configured such that the metrology position coordinate processing portion 190 is operable to determine a relative position (e.g., including local scale coordinates, which may indicate the scale orientation, location, etc.) between each camera 161 and 162 (e.g., as may correspond to a reference position REF1 and REF2 of the corresponding camera) and the scale 171 and 172 (e.g., based on determining an image position of the identified at least one respective imageable feature in each acquired image). The determined relative positions (e.g., which may indicate and/or be utilized to determine the angular orientations and/or bending and/or twisting of the arm portions 121 and 122) may be utilized to determine the metrology position coordinates of the end tool position ETP at the image acquisition time, with an accuracy level that is better than the robot accuracy. In various implementations, the supplementary metrology position determination system 150 may be configured to determine the metrology position coordinates of the end tool position ETP at the image acquisition time, based at least in part on the determined relative positions.

As noted above, the robot accuracy may be related to a model (e.g., kinematic, geometric, etc.) and/or corresponding calculations or other processes that are utilized for determining the end tool position. In accordance with such robot processes, the determination of the end tool position may generally be based on the known lengths of the first and second arm portions 121 and 122, which are assumed to be level and straight and to not bend or twist, and the rotation about the first and second rotary joints 131 and 132, which is assumed to be precise, with centered rotary motion around each respective rotary axis of each rotary joint. When there are undesirable movements (e.g., bending or twisting of the arm portions, rotary joint motion transverse to the respective rotary axis, etc.) the robot determination of the end tool position may be inaccurate. In accordance with principles disclosed herein, by utilizing the supplementary metrology position determination system 150 that is able to determine, measure, and/or otherwise account for such undesirable motions (e.g., bending or twisting of arm portions, rotary joint motion transverse to a rotary axis, etc.), a higher accuracy for a determination of an end tool position and/or other robot motion/positioning may be achieved. For example, with regard to an example kinematic and/or geometric model that is assumed by the robot system (e.g., with straight robot arms of specified lengths and perfect rotation), by determining/adding additional measured information to such a model, more accurate position information can be determined.

For example, rather than assuming each of the first and second arm portions 121 and 122 are straight, the respective camera/scale combinations 161/171 (for the first arm portion 121) and 162/172 (for the second arm portion 122) may provide position information/measurements that represent any bending, twisting, etc. of the arm portions 121 and 122 (as well as providing position information/measurements indicating the more standard angular orientation of the respective arm portions 121 and 122 with a high level of accuracy). By including such information (e.g., as part of a kinematic and/or geometric model, calculations, etc.) for determining the positions of the robot arms and/or the end tool position (e.g., at a distal end of the movable arm configuration MAC), etc., a higher level of accuracy may be achieved.

In certain implementations, the supplementary metrology position determination system 150 may operate relatively independently (e.g., from the robot processing portion 145) for the higher accuracy determinations (e.g., of the end tool position, etc.) In other implementations, the supplementary metrology position determination system 150 may operate in conjunction (e.g., with the robot processing portion 145 and/or control and sensing portions or other portions of the robot and/or other systems) for achieving the higher accuracy determinations. For example, the supplementary metrology position determination system 150 may receive certain information from the robot system (e.g., from the robot position processing portion, or control and sensing portions, or otherwise) for combining, supplementing and/or adding to determined position information (e.g., for determining an end tool position, etc.) As another example, the supplementary metrology position determination system 150 may provide certain information to the robot system, or other system that may combine certain position information from the robot and supplementary systems, for combining, supplementing and/or adding to determined position information (e.g., for determining an end tool position, etc.).

It will be appreciated that such a system may have certain advantages over various alternative systems. For example, in various implementations a system such as that disclosed herein may be smaller and/or less expensive than alternative systems utilizing technologies such as laser trackers or photogrammetry for tracking robot movement/positions, and may also have higher accuracy in some implementations. The disclosed system also does not take up or obscure any part of the operable work volume OPV, such as alternative systems that may include a scale or fiducial on the ground or stage, or otherwise in the same area (e.g., operable work volume) where workpieces may otherwise be worked on and/or inspected, etc. In addition, in various implementations by having all of the cameras and scales coupled to the robot (e.g., including as coupled to moving portions of the movable arm configuration such as arm portions and rotary joints), no external structure or external coupling in the robot environment needs to be provided for the cameras or scales.

FIG. 2 is an isometric diagram of a second exemplary implementation of a robot system 200 substantially similar to the robot system 100 of FIG. 1. It will be appreciated that certain numbered components (e.g., 1XX or 2XX) of FIG. 2 may correspond to and/or have similar operations as identically or similarly numbered counterpart components (e.g., 1XX) of FIG. 1, and may be understood to be similar or identical thereto and may otherwise be understood by analogy thereto and as otherwise described below. This numbering scheme to indicate elements having analogous and/or identical design and/or function is also applied to other figures described below.

In the configuration of FIG. 2 (i.e., similar to the configuration of FIG. 1), the supplementary metrology position determination system includes the cameras 161 and 162, each directed at the corresponding scales 171 and 172, and each coupled (e.g., attached) to the respective arm portions 121 and 122 (e.g., at or near the distal ends of the respective arm portions 121 and 122). In various implementations, different reference axes and lines may be designated for referencing certain movements, coordinates and angles of the components of the articulated robot. For example, the first and second arm portions 121 and 122 may each have designated nominally horizontal center lines CT1 and CT2, respectively, passing down the centers of the respective arm portions. An angle A1 may be designated as occurring between the center line CT1 of the first arm portion 121 and a plane (e.g., an x-z plane) in accordance with an amount of rotation of the first motion mechanism 131 about the first rotary axis RA1. An angle A2 may be designated as occurring between a plane of the horizontal center line CT1 of the first arm portion 121 (e.g., a plane corresponding to the horizontal center line CT1 and a z-axis direction) and the horizontal center line CT2 of the second arm portion 122, in accordance with an amount of rotation of the second motion mechanism 132 about the second rotary axis RA2.

In various implementations, the end tool configuration ETCN may be coupled to the second arm portion 122 proximate to the distal end DE2 of the second arm portion 122 and may be designated as having an end tool axis EA of the end tool ETL that nominally intersects the center line CT2 of the second arm portion 122. The end tool position ETP may be designated as having coordinates of X2, Y2, Z2 (e.g., in the robot coordinate system (RCS)). In various implementations, the end tool ETL may have a contact point CP (e.g., at the end of an end tool stylus ETST for contacting a workpiece) which may be designated as having coordinates X3, Y3, Z3 (e.g., in the RCS). In an implementation where the contact point CP of the end tool ETL does not vary in the x or y directions relative to the rest of the end tool, the X3 and Y3 coordinates may in some instances be nominally equal to the X2 and Y2 coordinates, respectively. It will be appreciated that in instances where there may be determinations of bending or twisting of arm portions 121 and 122 (i.e., in accordance with principles described herein) the resulting model (e.g., kinematic, geometric, etc.) may indicate that the X3 and Y3 coordinates may be different than the X2 and Y2 coordinates. For example, the bent or twisted arm portions may result in a corresponding tilt etc. of the end tool ETL, for which the measurement/determination of the amount of bending/twisting can be included in the model for determining a more accurate indication of the coordinates X3 and Y3 relative to the coordinates X2 and Y2, etc.

In one specific example implementation, each acquired image of the respective cameras 161 and 162 may be analyzed by the metrology position coordinate processing portion 190 to determine a relative position (e.g., corresponding to an angular orientation, location, etc. of the respective cameras 161 and 162 and/or arm portions 121 and 122, etc.). Such determinations may be made in accordance with standard camera/scale image processing techniques (e.g., for determining a location, orientation, etc. of camera relative to a scale). Various examples of such techniques are described in U.S. Pat. Nos. 6,781,694; 6,937,349; 5,798,947; 6,222,940; and 6,640,008, each of which is hereby incorporated herein by reference in its entirety. In various implementations, such techniques may be utilized to determine the location of a field of view (e.g., as corresponding to a position of a camera) within a scale range (e.g., within each scale 171 and 172), as will be described in more detail below with respect to FIGS. 5-7. In various implementations, such a determination may include identifying at least one respective imageable feature included in the acquired image of the respective scale and the related respective known scale coordinate location. Such a determination may correspond to determining a relative position (e.g., including local scale coordinates, which may indicate the orientation, location, etc.) between each camera 161 and 162 (e.g., as may correspond to a reference position REF1 and REF2 of the corresponding camera) and the scale 171 and 172 (e.g., based on determining an image position of the identified at least one respective imageable feature in each acquired image). The determined relative positions (e.g., which may indicate and/or be utilized to determine the angular orientations and/or bending and/or twisting of the arm portions 121 and 122) may be utilized to determine the metrology position coordinates of the end tool position ETP, with an accuracy level that is better than the robot accuracy.

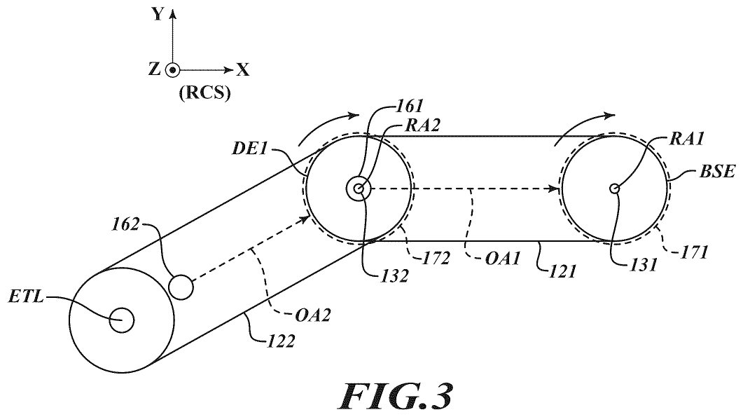

FIG. 3 is a bottom view of a portion of a robot system similar to that shown in FIGS. 1 and 2. More specifically, FIG. 3 shows a bottom view of first and second arm portions 121 and 122, first and second rotary joints 131 and 132, cameras 161 and 162, and scales 171 and 172. The scale 171 is coupled at a scale coupling location that is on the base portion BSE (e.g., as wrapped around at least part of the base portion BSE), and the scale 172 is coupled at a scale coupling location that is on the first arm portion 121 (e.g., as wrapped around at least part of the distal end DE1 of the first arm portion 121).

From the bottom view of FIG. 3, only the bottom edges of the scales 171 and 172 are visible, and which are represented as dotted lines (e.g., as coupled to/wrapped around portions of the respective base portion BSE and distal end DE1 of the first arm portion 121).

As described above, the cameras 161 and 162 are positioned such that they can obtain images of the scales 171 and 172, respectively. Based on those images, the metrology position coordinate processing portion 190 determines the respective angular orientations of the arm portions 121 and 122 (e.g., as based on relative positions of a center of the field of view of each camera along a rotary measurement axis direction on the respective scale). As an example, in the orientation illustrated in FIG. 3, the center of the field of view of the camera 162 (e.g., which may correspond to a location where the optical axis OA2 of the camera 162 intersects the scale 172) may be determined (e.g., based on analysis of a corresponding image) to be directed to an identifiable position on the scale 172 (e.g., in accordance with identifiable scale elements/features on the scale 172 as will be described in more detail below). In the specific example illustrated in FIG. 3, this may indicate that the camera 162 and the corresponding arm portion 122 are at a determined angle (e.g., of −30 degrees in relation to the arm portion 121). In contrast, if the arm portion 122 was rotated to be aligned/coaxial, etc. with the arm portion 121, the center of the field of view of the camera 162 may be determined (e.g., based on analysis of a corresponding image) to be directed to an identifiable position on the scale 172 which would indicate that the camera 162 and the corresponding arm portion 122 were then at a determined angle (e.g., of 0 degrees in relation to the arm portion 121).

An angular orientation of the arm portion 121 may similarly be determined. As an example, in the orientation illustrated in FIG. 3, the center of the field of view of the camera 161 (e.g., which may correspond to a location where the optical axis OA1 of the camera 161 intersects the scale 171) may be determined (e.g., based on analysis of a corresponding image) to be directed to an identifiable position on the scale 171 (e.g., in accordance with identifiable scale elements/features on the scale 171 as will be described in more detail below). In the specific example illustrated in FIG. 3, this may indicate that the camera 161 and the corresponding arm portion 121 are at an angle relative to a reference position (e.g., for which the reference position may be as illustrated in FIG. 3, for which the arm portion 121 may thus be at an angle of 0 degrees). In contrast, if the arm portion 121 was rotated away from the reference position, the center of the field of view of the camera 161 may be determined (e.g., based on analysis of a corresponding image) to be directed to an identifiable position on the scale 171 which would indicate that the camera 161 and the corresponding arm portion 121 were then at an angle different from 0 degrees (e.g., in relation to the reference position as illustrated in FIG. 3).

Also based on the images, the metrology position coordinate processing portion 190 determines any undesirable bending of the arm portions 121 and 122 (e.g., as based on relative positions of a center of the field of view of each camera along a transverse direction that is transverse to the rotary measurement axis direction on the respective scale). Also based on the images, the metrology position coordinate processing portion 190 determines any undesirable twisting of the arm portions 121 and 122 (e.g., as based on a relative rotation of the field of view of each camera on the respective scale). In various implementations, the ability to detect such undesirable bending or twisting of the robot arms may be advantageous over prior robot position determination methods (e.g., such as those utilizing only encoders included in the first and second rotary joints 131 and 132) which would not normally detect or account for such bending and twisting and would thus result in measurement errors in relation to determining the end tool position at the end of the movable arm configuration MAC.

In various implementations, the supplementary metrology position determination system 150 may be “self-contained” in that it does not obtain the rotary information from the robot encoders for the first and second rotary joints 131 and 132. Instead, the supplementary metrology position determination system 150 obtains images of the scales 171 and 172, and determines rotary information (e.g., angular orientations) of the first and second rotary arm portions 121 and 122. The supplementary metrology position determination system 150 also determines relative positions/displacement corresponding to bending and/or twisting of the first and second arm portions 121 and 122. The angular orientations (e.g., corresponding to rotary information) of the first and second arm portions determined by the supplementary metrology position determination system 150 in various implementations may typically be more accurate than the angular orientations of the first and second arm portions 121 and 122 as determined by the robot encoders included in the rotary joints 131 and 132. In other implementations, the position information from the supplementary metrology position determination system 150 may be utilized in combination with the position information from the robot encoders included in the rotary joints 131 and 132. For example, the supplementary metrology position determination system 150 may provide highly precise incremental position information, while the robot encoders included in the rotary joints 131 and 132 may provide relatively coarser absolute position information, which may be combined for determining a highly precise absolute position, such as corresponding to a highly precise rotary orientation of each arm portion 121 and 122, etc.

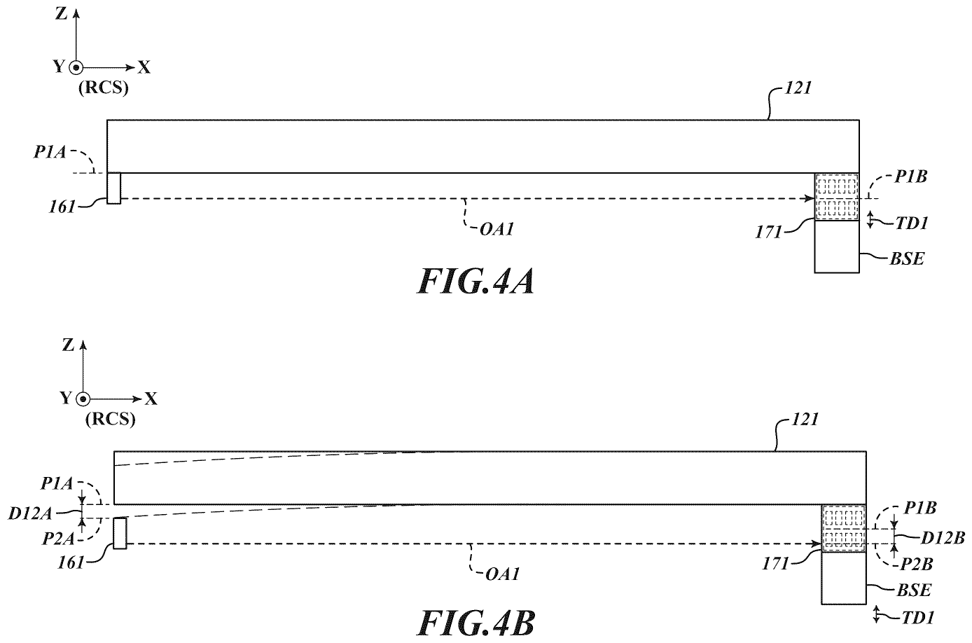

FIGS. 4A and 4B are side views of a portion of a robot system similar to that shown in FIGS. 1 and 2. More specifically, FIGS. 4A and 4B show a side view of a first arm portion 121, camera 161 (e.g., with an optical axis OA1) and scale 171. Although not shown in FIGS. 4A and 4B, the scale 172 is positioned around the end of the arm portion 121 (e.g., above the coupling location of the camera 161, such as illustrated in FIG. 1). FIG. 4A illustrates a condition of the arm portion 121 in which the arm portion is not bent, while FIG. 4B illustrates a condition of the arm portion 121 in which the arm portion is bent (e.g., a “bent condition”).

More specifically, in various implementations the first arm portion 121, second arm portion 122 and/or an end tool coupled to the second arm portion 122 and/or other elements may be sufficiently heavy to cause bending of the first arm portion 121, as shown by dashed lines in FIG. 4B (e.g., for which the bending is noted to be exaggerated in FIG. 4B for purposes of illustrating some of the effects). Such bending may cause a change in a relative position of the camera 161, wherein an upper portion of the camera moves from an expected position P1A (e.g., as illustrated in FIG. 4A) to a bent position P2A (e.g., as illustrated in FIG. 4B). A corresponding amount of movement/position change D12A (e.g., as illustrated in FIG. 4B) can be detected/measured in accordance with the movement of the camera 161 (i.e., and the center of the field of view of the camera 161) relative to the scale 171 (e.g., in accordance with analysis of images of the scale 171 as taken by the camera 161).

More specifically, when the arm portion 121 is bent as illustrated in FIG. 4B, the field of view of the camera 161 will show a different portion of the scale 171 (e.g., closer to the bottom of the scale 171 in the illustrated example, as compared to the position illustrated in FIG. 4A). A corresponding image from the camera 161 can be analyzed to determine the position of the camera 161 and the corresponding amount of bending of the first arm portion 121 (e.g., based at least in part on determinations of different positions of one or more imageable features of the scale, such as in different images corresponding to an initial unbent position and a subsequent bent position, etc.) It will be appreciated that similar bending of the arm portion 122 may be determined (e.g., in accordance with images from the camera 162 of the scale 172 which can be analyzed to determine bending of the arm portion 122).

In the illustrated example, the center of the field of view of the camera 161 (e.g., as corresponding to a position where the optical axis OA1 intersects the scale 171) moves from an expected position P1B (e.g., as illustrated in FIG. 4A) to a bent position P2B (e.g., as illustrated in FIG. 4B). A corresponding amount of movement/position change D12B can be detected/measured in accordance with analysis of an image or images of the camera 161, which indicate the different positions of the center of the field of view of the camera 161 on the scale 171. As indicated, the bending of the arm portion 121 (e.g., as illustrated in FIG. 4B) causes a movement/change in position of the field of view of the camera 161 (e.g., including the center of the field of view) along a transverse direction TD1 (e.g., that is transverse to a first rotary measurement axis direction MA1, which may follow around the curve of the scale 171, such as illustrated in FIG. 2).

It will be appreciated that the effects as shown in FIG. 4B have been simplified for purposes of the illustration, but for which it will be understood that in various implementations the movement of the center of the field of view of the camera 161 may have different levels of complexity. For example, in certain implementations, the optical axis OA1 may be tilted by a tilting of the camera 161 as the arm portion 121 bends, etc., and for which movements/changes in position of the center of the field of view of the camera 161 on the scale 171 may be associated with and/or otherwise made to corresponded to bending amounts of the arm portion 121 (e.g., in accordance with corresponding calculations and/or calibration data that is collected in relation to such positions, effects, etc.). It will also be appreciated that the term “transverse” as utilized herein is intended to indicate a relationship between elements, directions, motions, etc. that are oriented at a certain angle relative to one another, for which the angle may be 90° (e.g., corresponding to a perpendicular relationship) or may be another angle (e.g., but for which the elements, directions, motions, etc. are not parallel to one another).

It will be appreciated that the configuration as illustrated in FIGS. 4A and 4B may have certain advantages over certain alternative configurations.

For example, in some instances a rotary joint of an arm portion (e.g., a rotary joint 131 of the arm portion 121) may have issues with a certain amount of “wobble” or “slop” in the movement of the joint, or other such issues. In some such instances, the entire arm portion 121 (e.g., in particular the distal end of the arm portion) may bend downward (e.g., for which that type of bending may also be characterized as tilting downward), even if the arm portion 121 itself remains perfectly straight (e.g., such as may be enabled by certain undesirable issues with the rotary joint 131). In such cases, the configuration as illustrated in FIGS. 4A and 4B will still detect such bending (e.g., tilting) of the arm portion 121, due to the fact that the camera 161 is coupled to the arm portion 121, while the scale 171 is coupled to the base portion BSE (i.e., for which such relative movement between the distal end of the arm portion 121 and the base portion BSE can be detected). Similar motion can be detected for the arm portion 122, in that the camera 162 is coupled to the arm portion 122, while the scale 172 is coupled to the distal end of the arm portion 121 (i.e., for which relative movement between the distal end of the arm portion 122 and the distal end of the arm portion 121 can be detected). Such configurations may be contrasted with certain alterative configurations, such as in which both a camera and a scale are coupled to single arm portion (e.g., for detecting bending of the arm portion), but for which if the arm portion itself remains perfectly straight (e.g., even if the distal end of the arm portion tilts downward) no bending will be detected (i.e., due to the camera and the scale remaining in the same relative positions/orientations with respect to one another on the straight arm portion).

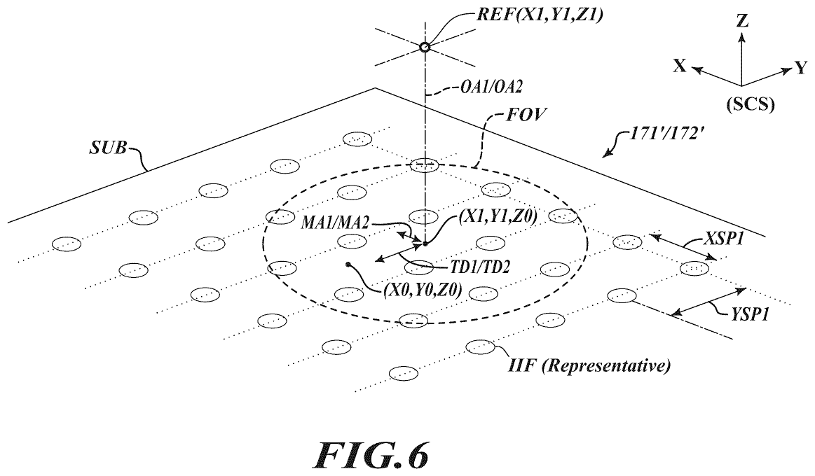

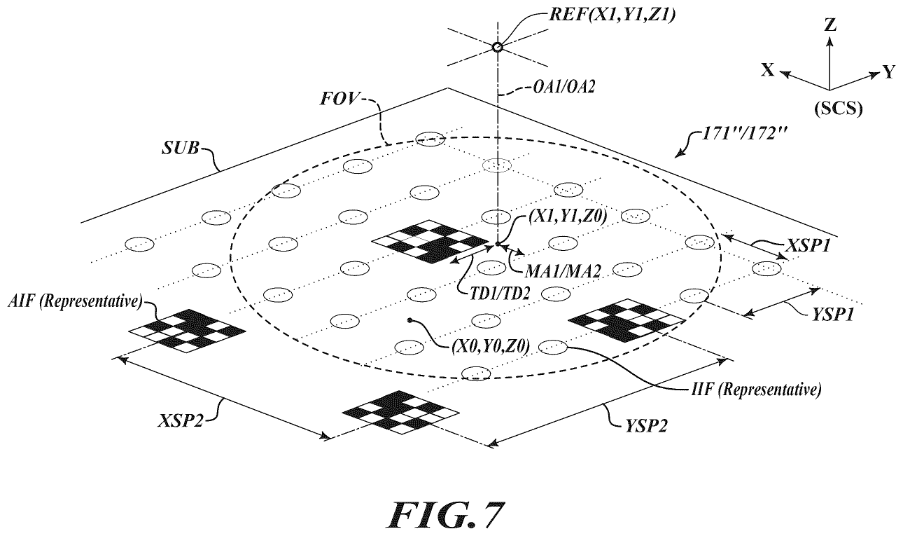

FIG. 5 is a diagram of an exemplary implementation of an incremental scale 171/172, FIG. 6 is an isometric diagram of an exemplary implementation of an incremental scale 171′/172′, and FIG. 7 is an exemplary implementation of an absolute scale 171″/172″. In various implementations, any of the scales 171/172, 171′/172′, or 171″/172″ may be utilized for or otherwise representative of any of the scales 171 and 172 of FIGS. 1-4 (e.g., for which any grid-like or other features of the scales as illustrated in FIGS. 1-4 may be considered to be representative of or otherwise replaced by any of the scale features as illustrated in FIG. 5-7).

For simplicity of the illustrations and the description of the scale elements and corresponding position detection, the scales in FIGS. 5-7 are shown in a planar format (e.g., as they may exist in some instances before being wrapped around the curved surfaces such as the base portion BSE and/or the distal end of the arm portion 121, etc.) More specifically, it will be appreciated that when the scales are coupled to the movable arm configuration MAC (e.g., as illustrated in FIGS. 1-4B), the scales may be curved (e.g., in an at least partially cylindrical or other curved shape as at least partially wrapped around the base portion BSE and/or distal end of the arm portion 121, etc.) The following principles as described with respect to the illustrations of the planar scales in FIGS. 5-7 will be understood to equally apply to the images of the scales (e.g., as acquired by the cameras 161/162) for which at least central portions of the images of the scales will have similar features as those described below (e.g., as may be utilized for determining position information and/or other characteristics regarding the movable arm portions, etc.) Also for simplicity of the illustrations, the planar format of the scales are illustrated from the perspective of a camera (e.g., camera 161/162) looking down at the respective scales. In this regard, in FIGS. 6 and 7, a reference position REF (e.g., a reference position REF as related to a position of a camera) is shown above the scales, with an optical axis OA1/OA2 directed down toward the scales, such as along the z-axis direction of the local scale coordinate system (SCS) (e.g., for which this will be understood in relation to the examples of FIGS. 1 and 2 to correspond to a primarily horizontal view, such as indicated by the primarily horizontal orientations of the optical axes OA1/OA2 in FIGS. 1 and 2).

As illustrated in FIG. 5, the incremental scale 171/172 includes an array of evenly spaced incremental imageable features IIF distributed on a flexible substrate SUB. In certain implementations, the flexible substrate SUB (e.g., of FIGS. 5-7) may have an adhesive backing or other attachment mechanism (e.g., in the form or a sticker or similar configuration for being wrapped around and/or otherwise coupled to a corresponding portion of the movable arm configuration MAC, such as may be at least partially wrapped around the base portion BSE and/or distal end of the arm portion 121, etc.). In various implementations, the incremental scale 171/172 may have a specified periodicity (e.g., smaller than 100 microns for which periodic spacings between the incremental imageable features IIF along the respective x and y axes may each be less than 100 microns, as will be described in more detail below with respect to the example of FIG. 6). In one specific example implementation, the scale 171/172 may be designated as having a reference position (e.g., an origin location) at scale coordinates X0, Y0, Z0 (e.g., in a local scale coordinate system), as will also be described in more detail below with respect to the example of FIG. 6. In various implementations, in the examples of FIGS. 5-7, a rotary measurement axis direction MA1/MA2 (e.g., as illustrated in FIG. 2 and as may follow around the curve of the scale) may at least approximately correspond to an x-axis direction (e.g., in the local scale coordinate system). A transverse direction TD1/TD2 (i.e., which is transverse to the rotary measurement axis direction MA1/MA2) may at least approximately correspond to a y-axis direction (e.g., in the local scale coordinate system).

FIG. 6 is an isometric diagram of an exemplary implementation of an incremental scale 171′/172′. As illustrated in FIG. 6, the incremental scale 171′/172′ includes an array of evenly spaced incremental imageable features IIF distributed on a flexible substrate SUB (e.g., as may be at least partially wrapped around the base portion BSE and/or distal end of the arm portion 121). In the examples of FIGS. 6 and 7, only part of the pattern of incremental imageable features IIF is illustrated, but it will be appreciated that in various implementations the pattern may extend as far as the scale 171′/172′ or 171″/172″ extends. In various implementations, the incremental scale 171′/172′ of FIG. 6 may have a periodicity that is smaller than 100 microns (e.g., for which periodic spacings XSP1 and YSP1 between the incremental imageable features IIF along the respective x and y axes may each be less than 100 microns). In various implementations, the position information that is determined utilizing the incremental scale 171′/172′ may have an accuracy of at least 10 microns. In contrast to a robot accuracy that may be approximately 100 microns in certain implementations, the accuracy determined utilizing such scales may be at least 10x that of the robot accuracy. In one specific example implementation, the incremental scale 171′/172′ may have an even higher periodicity of approximately 10 microns, for which, if the magnification of the respective camera is approximately 1× and interpolation is performed by a factor of 10×, an approximately 1 micron accuracy may be achieved.

In various implementations, a location of a field of view FOV of the respective camera (e.g., camera 161/162) within the incremental scale 171′/172′ may provide an indication of a relative position between the respective camera (e.g., with the reference position REF) and the scale 171′/172′. In various implementations, the respective camera (e.g., camera 161/162) may be utilized in combination with the incremental scale 171′/172′ as part of a camera/scale image processing configuration. For example, the metrology position coordinate processing portion 190 may determine a relative incremental position of the camera 161/162 and the corresponding reference position REF (e.g., reference position REF1/REF2 which corresponds to and/or is indicative of a position of the corresponding camera 161/162) relative to the scale 171′/172′. Such may be determined based on the location of the field of view FOV within the incremental scale 171′/172′, as indicated by the portion and orientation of the scale 171′/172′ (e.g., in accordance with the position and orientation of one or more of the imageable features IFF) in the acquired image (e.g., which may indicate the location, orientation, etc. of the camera 161/162 and reference position relative to the respective scale 171′/172′), and as is known in the art for camera/scale image processing techniques (e.g., as described in the previously incorporated references). In various implementations, the incremental scale 171′/172′ may be of various sizes relative to the field of view FOV (e.g., the incremental scale 171′/172′ may be larger than the FOV so that when the camera is moved relative to the respective scale, the captured image will still be filled by a portion of the scale, and for which the scale may be at least 2×, 4×, etc. larger than the field of view FOV). In further relation to such dimensional considerations, it may also be desirable for the field of view to be small enough relative to the scale such that the curvature of the scale (e.g., as at least partially wrapped around the base portion BSE and/or distal end of the arm portion 121) does not significantly distort the determinations in relation to the scale features at or near the edges of the field of view, etc.

In various implementations, the incremental position indicated by the scale 171′/172′ may be combined with position information from other scales, other sensors, and/or the articulated robot 110 to determine a relatively precise and/or absolute position (e.g., of the end tool). For example, the sensors SEN1 and SEN2 (e.g., rotary encoders) of the articulated robot 110 may indicate the end tool position ETP with the robot accuracy, for which the incremental positions indicated by the scales 171′/172′ may be utilized to determine and/or further refine the determined end tool position ETP to have an accuracy that is better than the robot accuracy. In one such configuration, the metrology position coordinate processing portion 190 may be configured to identify one or more respective imageable features IIF included in each acquired image of each scale 171′/172′ and determine the image positions of the one or more imageable features IFF in the acquired images.

As described above with respect to FIG. 2, in one specific example implementation, the scale 171′/172′ may be designated as having a reference position (e.g., an origin location) at X0, Y0, Z0 (e.g., which for an origin location may have values of 0,0,0), in accordance with a local scale coordinate system (e.g., as may be related to a corresponding local camera coordinate system, and as may be contrasted with a robot coordinate system such as illustrated in FIGS. 1 and 2, although for which conversions may be made between the various coordinate systems). In such a configuration, the reference location (e.g., reference location REF) may be at relative coordinates of X1, Y1, Z1, and a center of a corresponding field of view FOV (e.g., as captured in an acquired image) may be at relative coordinates of X1, Y1, Z0. In various implementations, in the scale coordinate system, all coordinates on the scale may have Z positions of Z0, while the corresponding reference location (e.g., reference location REF which may correspond to and/or indicate the location of the camera 161/162) may have a different relative Z location relative to the scale, with a corresponding Z position of Z1 (e.g., along the optical axis of the camera). In various implementations, the center of the field of view FOV at the coordinates X1, Y1 may be along the optical axis (e.g., optical axis OA1/OA2) of the respective camera (e.g., camera 161/162), which in some configurations may be assumed to be nominally perpendicular to the scale, and for which the reference location REF may also be along the optical axis, thus having the same XY coordinates of X1, Y1 as the center of the field of view FOV.

In operation, an acquired image may be analyzed by the metrology position coordinate processing portion 190 to determine the X1, Y1 coordinates corresponding to the center of the field of view FOV of the respective camera. In various implementations, such a determination may be made in accordance with standard camera/scale image processing techniques, for determining a location of a field of view (e.g., corresponding to a location of a camera) within a scale range (e.g., within the scale 171′/172′). It will be appreciated that in accordance with standard camera/scale image processing techniques, the reference position/origin location X0, Y0, Z0 is not required to be in the field of view FOV for such a determination to be made (i.e., the relative position may be determined from the scale information at any location along the scale 171′/172′, as provided in part by the scale elements comprising the evenly spaced incremental imageable features IIF). In various implementations, such a determination may include identifying at least one respective imageable feature included in the acquired image of the scale and the related respective known scale coordinate location. Such a determination may correspond to determining a relative position of the camera 161/162 and/or the corresponding reference position REF 1/REF2 relative to the scale 171′/172′.

As noted above, once the relative positions of each of the cameras 161/162 and/or corresponding reference positions REF 1/REF2 are determined, such information may be utilized for other position determination and/or control processes (e.g., for determining and/or controlling the end tool position ETP, etc.). As indicated above, in some implementations the relative positions of the each of the cameras/reference positions may initially be expressed/determined in terms of local coordinate systems (e.g., scale and/or camera coordinate systems, etc.), and which may then be converted or otherwise processed in reference to a robot coordinate system. The end tool position ETP may be determined and/or controlled in accordance with the robot coordinate system and/or other coordinate system.

FIG. 7 is an isometric diagram of an exemplary implementation of an absolute scale 171″/172″. In the example of FIG. 7, similar to the incremental scale 171′/172′, the absolute scale 171″/172″ includes an array of evenly spaced incremental imageable features IIF, and also includes a set of absolute imageable features AIF having unique identifiable patterns (e.g., a 16-bit pattern). In operation, a location of a field of view FOV within the absolute scale 171″/172″ (i.e., as included in a captured image) provides an indication of an absolute position between the respective camera (e.g., with the reference position REF) and the scale 171″/172″. In the implementation of FIG. 7, the set of absolute imageable features AIF are distributed on the flexible substrate SUB (e.g., as may be at least partially wrapped around the base portion BSE and/or distal end of the arm portion 121) such that they are spaced apart (e.g., at spacings XSP2 and YSP2) by less than a distance corresponding to a distance across a field of view FOV of a respective camera (i.e., so that at least one absolute imageable feature AIF will always be included in a field of view). In operation, the metrology position coordinate processing portion 190 is configured to identify at least one respective absolute imageable feature AIF included in the acquired image of the scale 171″/172″ based on the unique identifiable pattern of the respective absolute imageable feature AIF, as part of a process for determining an absolute relative position of the respective camera and/or reference position in relation to the scale 171″/172″ (e.g., as may correspond to or otherwise indicate a relative location, orientation, etc. of the camera/reference position in relation to the scale 171″/172″, etc.)

A specific illustrative example of utilizing the absolute imageable features AIF to determine a relatively precise and absolute position is as follows. As illustrated in FIG. 7, the acquired image may indicate that the center of the field of view FOV is in the middle of a number of incremental imageable features IIF. The position information from the included two absolute imageable features AIF indicates which section of the scale 171″/172″ the image includes, for which the included incremental imageable features IIF of the scale may also be identified. The acquired image may, accordingly, be analyzed by the metrology position coordinate processing portion 190 to determine precisely where the center of the field of view (i.e., at the coordinates X1, Y1, Z0) occurs within that section of the scale (i.e., which includes the two absolute imageable features AIF and the incremental imageable features IIF). In various implementations, based on such information, the relative position of the camera/reference position may be determined (e.g., as may correspond to and/or otherwise be utilized for determining an angular orientation and/or bending/twisting of a corresponding arm portion 121/122, etc.)

As noted above, in various implementations, in the examples of FIGS. 5-7, a rotary measurement axis direction MA1/MA2 (e.g., as illustrated in FIG. 2 and as may follow around the curve of the scale) may at least approximately correspond to an x-axis direction (e.g., in the local scale coordinate system). A transverse direction TD1/TD2 (i.e., which is transverse to the rotary measurement axis direction MA1/MA2) may at least approximately correspond to a y-axis direction (e.g., in the local scale coordinate system). In various implementations, each of the cameras 161/162 is coupled to a respective arm portion 121/122 such that the camera is configured to rotate around the corresponding scale 171/172 and a field of view of the camera (e.g., as may be referenced in some instances according to a center point of the field of view) is configured to move along a rotary measurement axis direction MA1/MA2 on the scale 171/172 as the arm portion 121/122 is rotated around the rotary joint 131/132. In accordance with such configurations, a position of a field of view on a scale (e.g., as indicated by a camera image) may correspond to a particular rotary orientation of an arm portion, and a change in a position of a field of view on a scale (e.g., as indicated by a comparison between camera images) may correspond to a change in rotary orientation of an arm portion. In various implementations, determinations of such rotary orientations of the arm portions (e.g., in accordance with analysis of the corresponding images) may be performed based at least in part on corresponding calculations and/or calibration data that is collected in relation to such positions, effects, etc. (e.g., for which such calibration data and/or other calibration processes may be collected and/or otherwise performed after the scales 171/172 are coupled to the movable arm configuration MAC, etc.)

In some instances, a bending of an arm portion (e.g., which causes and/or otherwise corresponds to a movement of a field of view of a corresponding camera along a direction TD that is transverse to a rotary measurement axis direction MA on a corresponding scale) may be characterized as a type of “pitch” motion and/or “sag” motion. In some instances, a twisting of an arm portion (e.g., which causes and/or otherwise corresponds to a rotation of a field of view of a corresponding camera on a corresponding scale) may be characterized as a type of “roll” motion. With respect to a rotation of a field of view, in some instances one or more pixels of a field of view (e.g., of a camera) may be characterized/utilized as reference pixels (e.g., a pixel at a top center of a field of view and/or other pixels) for referencing and/or otherwise enabling a determination of an orientation of a field of view in relation to a portion of a scale that is included in the field of view (e.g., as included in an image from the camera). In accordance with such configurations, a position and/or orientation of a field of view on a scale (e.g., as indicated by a camera image) may correspond to a particular amount of bending and/or twisting of an arm portion, and a change in a position and/or orientation of a field of view on a scale (e.g., as indicated by a comparison between camera images) may correspond to a change in bending and/or twisting of an arm portion. In various implementations, determinations of such bending and/or twisting of the arm portions (e.g., in accordance with analysis of the corresponding images) may be performed based at least in part on corresponding calculations and/or calibration data that is collected in relation to such positions, effects, etc. (e.g., for which such calibration data and/or other calibration processes may be collected and/or otherwise performed after the scales 171/172 are coupled to the movable arm configuration MAC, etc.)

As noted above, in various implementations, the first and second scales 171 and 172 are curved (e.g., and in certain instances may be at least partially cylindrically shaped), for which the corresponding rotary measurement axis directions MA1 and MA2 may be correspondingly curved (e.g., and for which in some instances the corresponding transverse directions TD1 and TD2 may be approximately linear). For example, the first scale 171 may be at least partially wrapped/curved around at least part of the supporting base portion BSE (e.g., which may be at least partially cylindrically shaped). The second scale 172 may be at least partially wrapped/curved around at least part of the distal end DE1 of the first arm portion 121 (e.g., for which at least part of the distal end DE1 may be at least partially cylindrically shaped).

In various implementations, each of the absolute imageable features AIF of FIG. 7 may correspond to a particular angular orientation of a respective arm portion (i.e., as the arm portion is rotated around the respective rotary joint). As one example, as noted above, the scale 171″ may be curved around the base portion BSE, and the first arm portion 121 may be rotated around the rotary joint 131. In such a configuration, when the center of the field of view FOV of the camera 161 is aligned with a center of an absolute imageable feature AIF (e.g., when the centers are at a same x-axis coordinate or otherwise at a same coordinate along a rotary measurement axis direction MA1), the arm portion 121 may be determined to be at an angular orientation that is indicated by the absolute imageable feature AIF.

As one specific numerical example, the absolute imageable features AIF may be at a spacing XSP2 (i.e., along the x-axis and/or rotary measurement axis direction MA1) that corresponds to a particular amount of angular rotation of the arm portion (e.g., a 90 degree rotation). Thus, one absolute imageable feature AIF on a positive side of a reference position (e.g., an origin location) may correspond to a particular amount of positive angular rotation of the arm portion (e.g., a +45 degree rotation), while one absolute imageable feature AIF on a negative side of the reference position (e.g., the origin location) may correspond to a particular amount of negative angular rotation of the arm portion (e.g., a −45 degree rotation). Thus, when the center of the field of view FOV of the camera 161 is aligned with a center of the absolute imageable feature AIF on the positive side, the angular orientation (e.g., +45 degrees) of the arm portion may be determined, and when the center of the field of view FOV of the camera 161 is aligned with a center of the absolute imageable feature AIF on the negative side, the angular orientation (e.g., −45 degrees) of the arm portion may be determined. In such an example, the incremental imageable features IIF may similarly be at a spacing XSP1 (i.e., along the x-axis and/or rotary measurement axis direction MA1) that corresponds to a particular amount of angular rotation of the arm portion (e.g., a 30 degree rotation), such as where 3(XSP1)=XSP2 (e.g., as corresponding to 3(30 degrees)=90 degrees). In such configurations, when the center of the field of view FOV of the camera 161 is in between centers of the absolute imageable features AIF and/or centers of the incremental imageable features IIF, an angular orientation of the arm portion may be determined based at least in part on interpolation (e.g., based on a determined fractional spacing/position of the center of the field of view FOV between the centers of the respective imageable features, along the x-axis and/or rotary measurement axis direction MA1).

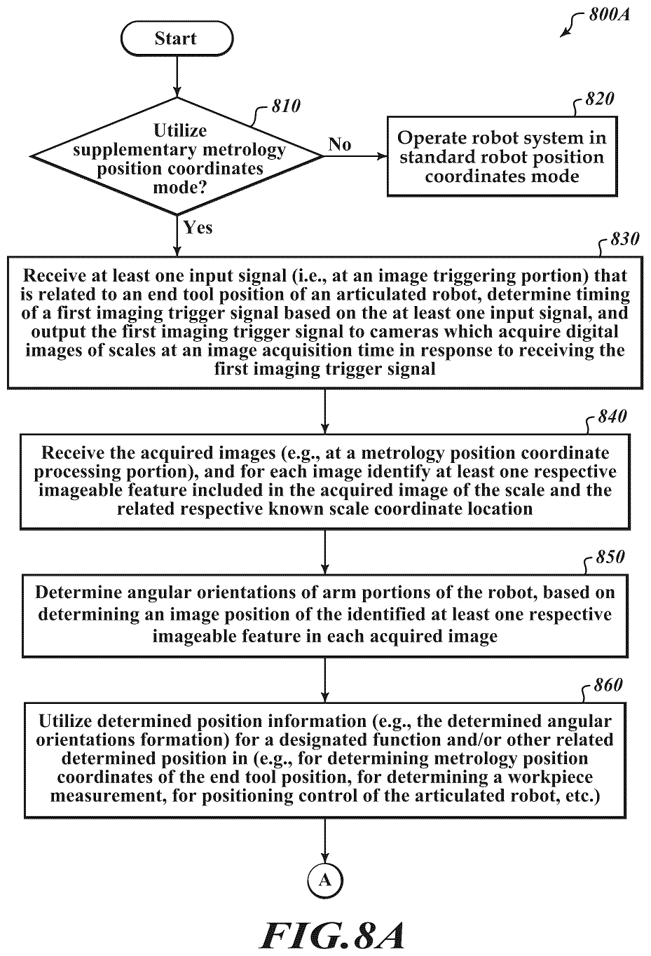

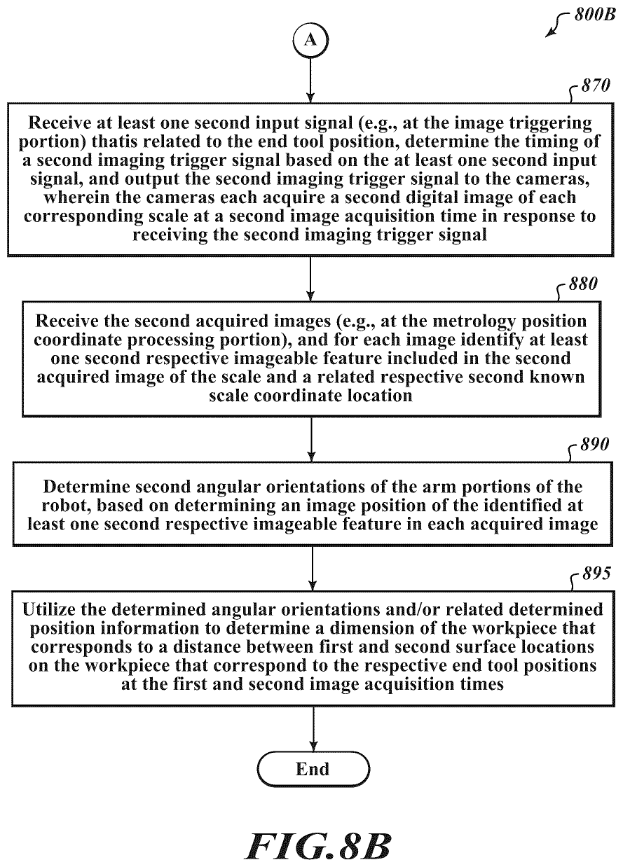

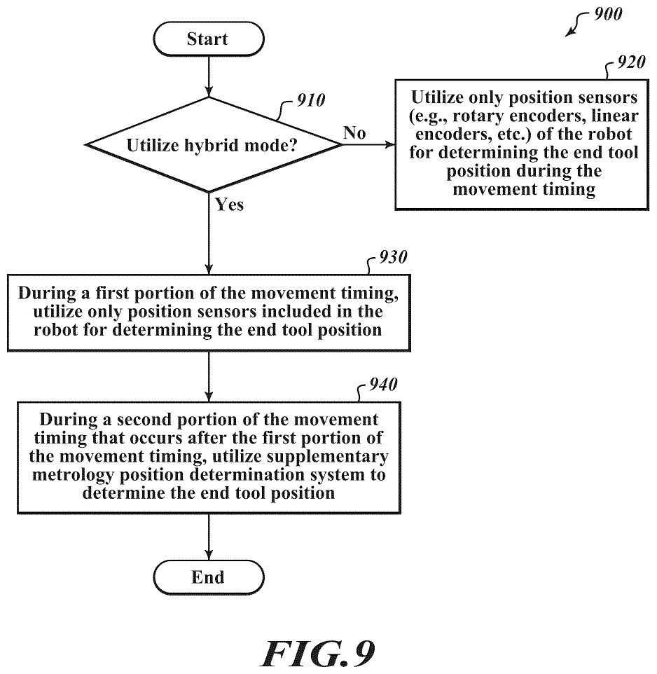

FIGS. 8A and 8B are flow diagrams illustrating exemplary implementations of routines 800A and 800B for operating a robot system including an articulated robot and a supplementary metrology position determination system. As shown in FIG. 8A, at a decision block 810, a determination is made as to whether the robot system is to be operated in a supplementary metrology position coordinates mode. In various implementations, a selection and/or activation of a supplementary metrology position coordinates mode or a standard robot position coordinates mode may be made by a user and/or may be automatically made by the system in response to certain operations and/or instructions. For example, in one implementation a supplementary metrology position coordinates mode may be entered (e.g., automatically or in accordance with a selection by a user) when the articulated robot moves into a particular position (e.g., moves an end tool from a general area where assembly or other operations are performed to a more specific area where workpiece inspection operations are typically performed and where the supplementary metrology position coordinates mode would be utilized). In various implementations, such modes may be implemented by an external control system ECS (e.g., such as the external control system ECS of FIG. 1 utilizing a standard robot position coordinates mode portion 147 and a supplementary metrology position coordinates mode portion 192). In various implementations, a hybrid mode may be operated either independently or as part of a supplementary metrology position coordinates mode and/or may be implemented as a switching between the modes, as will be described in more detail below with respect to FIG. 9.

If at the decision block 810 it is determined that the robot system is not to be operated in a supplementary metrology position coordinates mode, the routine proceeds to a block 820, where the robot system is operated in a standard robot position coordinates mode. As part of the standard robot position coordinates mode, the position sensors (e.g., rotary encoders) of the articulated robot are utilized to control and determine the articulated robot movements and corresponding end tool position with the robot accuracy (e.g., which is based at least in part on the accuracy of the position sensors of the articulated robot). In general, the robot position coordinates mode may correspond to an independent and/or standard mode of operation for the articulated robot (e.g., a mode in which the articulated robot is operated independently, such as when a supplementary metrology position determination system is not active or is otherwise not provided).

If the robot system is to be operated in a supplementary metrology position coordinates mode, the routine proceeds to a block 830, where at least one input signal is received (i.e., at a triggering portion) that is related to an end tool position of an articulated robot. A timing is determined of a first trigger signal based on the at least one input signal and the first trigger signal is output to the cameras of the supplementary metrology position determination system. The cameras each acquire a digital image of a corresponding scale at an image acquisition time in response to receiving the first trigger signal. At a block 840, the acquired images are received (e.g., at a metrology position coordinate processing portion), and for each image at least one respective imageable feature included in the acquired image of the scale and the related respective known scale coordinate location are identified.

At a block 850, an angular orientation of each arm portion is determined, based on determining an image position of the identified at least one respective imageable feature in each respective acquired image. At a block 860, determined position information (e.g., including the determined angular orientations and/or other related determined position information) is utilized for a designated function (e.g., for determining the metrology position coordinates of the end tool position, for a workpiece measurement, for positioning control of the articulated robot, etc.) As part of such operations or otherwise, the routine may then proceed to a point A, where in various implementations the routine may end, or may otherwise continue as will be described in more detail below with respect to FIG. 8B.

As indicated in FIG. 8B, the routine 800B may continue from the point A to a block 870. As will be described in more detail below, as part of the routine 800B, the determined position information (e.g., from the block 860) may correspond to or otherwise be utilized for determining a first surface location on a workpiece, and for which a second surface location on the workpiece may then be determined (e.g., as part of a workpiece measurement). At the block 870, at least one second input signal is received (e.g., at the triggering portion) that is related to the end tool position, and the timing of a second trigger signal is determined based on the at least one second input signal. The second trigger signal is output to the cameras of the supplementary metrology position determination system, wherein the cameras each acquire a second digital image of the corresponding scale at a second image acquisition time in response to receiving the second trigger signal.

At a block 880, the acquired images are received (e.g., at the metrology position coordinate processing portion), and for each image at least one second respective imageable feature included in the second acquired image of the scale and a related respective second known scale coordinate location are identified. At a block 890, a second angular orientation of each arm portion is determined, based on determining a second image position of the identified at least one second respective imageable feature in each respective second acquired image.

At a block 895, the determined angular orientations and/or related determined position information is utilized to determine a dimension of the workpiece that corresponds to a distance between the first and second surface locations on the workpiece that correspond to the respective end tool positions (e.g., as indicating the contact point positions, etc.) at the first and second image acquisition times. It will be appreciated that rather than using the position sensors (e.g., rotary encoders) of the articulated robot to determine the first and second surface locations on the workpiece with the robot accuracy, more accurate position information may be determined utilizing the techniques as described above.

FIG. 9 is a flow diagram illustrating one exemplary implementation of a routine 900 for determining an end tool position in which different techniques may be utilized during different portions of a movement timing. In general, during the movement timing one or more arm portions of the robot are moved from first positions to second positions (e.g., which may include rotating one or more arm portions around motion mechanisms from first rotary orientations to second rotary orientations, or otherwise moving the arm portions, etc.). As shown in FIG. 9, at a decision block 910, a determination is made as to whether a hybrid mode will be utilized for determining the end tool position during the movement timing. In various implementations, a hybrid mode may also be representative of a process which includes switching between the supplementary metrology position coordinates mode and the standard robot position coordinates mode, as described above with respect to FIG. 8A. If the hybrid mode is not to be utilized, the routine continues to a block 920, where the position sensors (e.g., rotary encoders, linear encoders, etc.) of the robot (e.g., of the movable arm configuration, such as movable arm configuration MAC, or MAC′, etc.) are solely utilized for determining the end tool position during the movement timing.

If the hybrid mode is to be utilized, the routine proceeds to a block 930, for which during a first portion of a movement timing, the position sensors included in the robot (e.g., included in the movable arm configuration MAC or MAC′ of the robot) are utilized for determining the end tool position. During such operations, a supplementary metrology position determination system may not be utilized to determine the end tool position. At a block 940, during a second portion of the movement timing that occurs after the first portion of the movement timing, the supplementary metrology position determination system is utilized to determine the end tool position. It will be appreciated that such operations enable the system to perform initial/fast/coarse movement of the end tool position during the first portion of the movement timing, and to perform more accurate final/slower/fine movement of the end tool position during the second portion of the movement timing.

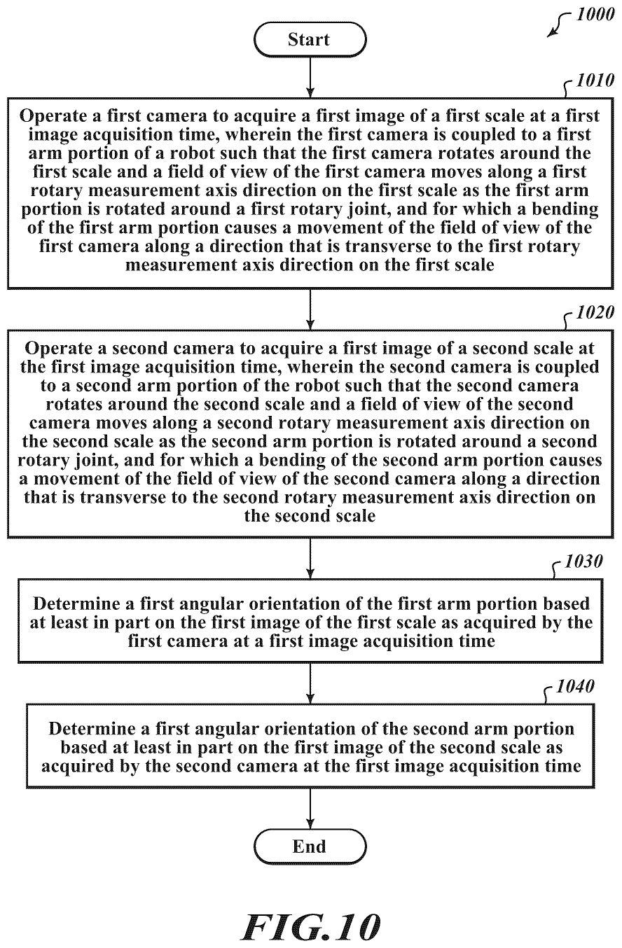

FIG. 10 is a flow diagram illustrating an exemplary implementation of a routine 1000 for operating a supplementary metrology position determination system that is utilized with a robot. As shown in FIG. 10, at a block 1010, a first camera is operated to acquire a first image of the first scale at a first image acquisition time, wherein the first camera is coupled to the first arm portion such that the first camera rotates around the first scale and a field of view of the first camera moves along a first rotary measurement axis direction on the first scale as the first arm portion is rotated around the first rotary joint, and for which a bending of the first arm portion causes a movement of the field of view of the first camera along a direction that is transverse to the first rotary measurement axis direction on the first scale. For example, the triggering portion 187 sends a control signal to the camera 161 that causes the camera 161 to acquire a first image of the scale 171 at the first image acquisition time.

At a block 1020, a second camera is operated to acquire a first image of the second scale at the first image acquisition time, wherein the second camera is coupled to the second arm portion such that the second camera rotates around the second scale and a field of view of the second camera moves along a second rotary measurement axis direction on the second scale as the second arm portion is rotated around the second rotary joint, and for which a bending of the second arm portion causes a movement of the field of view of the second camera along a direction that is transverse to the second rotary measurement axis direction on the second scale. For example, the triggering portion 187 sends a control signal to the camera 162 that causes the camera 162 to acquire a first image of the scale 172 at the first image acquisition time.

At a block 1030, a first angular orientation of the first arm portion is determined based at least in part on the first image of the first scale as acquired by the first camera at a first image acquisition time. For example, the metrology position coordinate processing portion 190 determines an angular orientation of the first arm portion 121 based on the first image of the scale 171 acquired by the camera 161 at the block 1010.

At a block 1040, a first angular orientation of the second arm portion is determined based at least in part on the first image of the second scale as acquired by the second camera at the first image acquisition time. For example, the metrology position coordinate processing portion 190 determines an angular orientation of the second arm portion 122 based on the first image of the scale 172 acquired by the camera 162 at the block 1020.

In some implementations, the method further includes determining at least one of: a bending amount of the first arm portion; a bending amount of the second arm portion; a twisting amount of the first arm portion; or a twisting amount of the second arm portion. In various implementations, a bending amount of the first arm portion may be determined based at least in part on the first image of the first scale as acquired by the first camera at the first image acquisition time (e.g., wherein the bending amount corresponds to a movement of the field of view of the first camera along a direction that is transverse to the first rotary measurement axis direction on the first scale). In various implementations, a bending amount of the second arm portion may be determined based at least in part on the first image of the second scale as acquired by the second camera at the first image acquisition time (e.g., wherein the bending amount corresponds to a movement of the field of view of the second camera along a direction that is transverse to the second rotary measurement axis direction on the second scale). In various implementations, a twisting amount of the first arm portion may be determined based at least in part on the first image of the first scale as acquired by the first camera at the first image acquisition time (e.g., wherein the twisting amount corresponds to a rotation amount of the field of view of the first camera). In various implementations, a twisting amount of the second arm portion may be determined based at least in part on the first image of the second scale as acquired by the second camera at the first image acquisition time (e.g., wherein the twisting amount corresponds to a rotation amount of the field of view of the second camera).

In some implementations, after the block 1040, metrology position coordinates of a first end tool position at the first image acquisition time are determined based at least in part on the determined angular orientations of the first and second arm portions (and/or based at least in part on determined bending or twisting of the first and second arm portions). For example, the metrology position coordinate processing portion 190 determines metrology position coordinates (X2, Y2, Z2) of the end tool position ETP (e.g., see FIG. 2) based at least in part on the determined angular orientations of the arm portions 121 and 122 (and/or based at least in part on determined bending or twisting of the first and second arm portions 121 and 122).

In some implementations, after the block 1040, the method further includes operating the first camera to acquire a second image of the first scale at a second image acquisition time, operating the second camera to acquire a second image of the second scale at the second image acquisition time, determining a second angular orientation of the first arm portion (and/or a bending or twisting of the first arm portion) based at least in part on the second image of the first scale as acquired by the first camera at the second image acquisition time, and determining a second angular orientation of the second arm portion (and/or a bending or twisting of the second arm portion) based at least in part on the second image of the second scale as acquired by the second camera at the second image acquisition time. For example, the acts described above in connection with the blocks 1010, 1020, 1030, and 1040 are repeated at a different time (i.e., the second image acquisition time).

In some implementations, the method further includes determining metrology position coordinates of a first end tool position at the first image acquisition time based at least in part on the determined first angular orientations of the first and second arm portions (and/or based at least in part on determined first bending or twisting of the first and second arm portions), and determining metrology position coordinates of a second end tool position at the second image acquisition time based at least in part on the determined second angular orientations of the first and second arm portions (and/or based at least in part on determined second bending or twisting of the first and second arm portions). For example, the metrology position coordinate processing portion 190 determines metrology position coordinates (e.g., X2a, Y2a, Z2a, not shown) of the end tool position ETP based at least in part on the determined first angular orientations of the first and second arm portions 121 and 122 (and/or based at least in part on determined first bending or twisting of the first and second arm portions), and determines metrology position coordinates (e.g., X2b, Y2b, Z2b, not shown) of the end tool position ETP based at least in part on the determined second angular orientations of the first and second arm portions 121 and 122 (and/or based at least in part on determined second bending or twisting of the first and second arm portions).

In some implementations, the method further includes utilizing the determined metrology position coordinates of the first and second end tool positions to determine a dimension that is related to a distance between the first and second end tool positions. For example, the metrology position coordinate processing portion 190 calculates a distance between the first and second end tool positions using the metrology position coordinates (X2a, Y2a, Z2a) and the metrology position coordinates (X2b, Y2b, Z2b) mentioned above, and determines a dimension that is related to the distance between the first and second end tool positions. The dimension may be or correspond to a distance between first and second surface locations on a workpiece, wherein a contact point of the end tool contacts the first surface location on the workpiece at the first image acquisition time and contacts the second surface location on the workpiece at the second image acquisition time.

In some implementations, before the block 1010, the method further includes coupling the first and second scales to the movable arm configuration at the first and second scale coupling locations, respectively, coupling the first camera to the first arm portion at the first camera coupling location, and coupling the second camera to the second arm portion at the second camera coupling location. For example, the method includes coupling the scale 171 to the base portion BSE at the scale coupling location CL2, coupling the scale 172 to the distal end DE1 of the first arm portion 121 at the scale coupling location CL4, coupling the camera 161 to the distal end DE1 of the first arm portion 121 at the camera coupling location CL1, and coupling the camera 162 to the distal end DE2 of the second arm portion 122 at the camera coupling location CL3.

It will be understood that a “scale” as referenced herein should be understood to refer to any reference scale comprising a plurality of features or markings that correspond to known dimensional coordinates on that reference scale (e.g. accurate and/or accurately calibrated locations), provided that the scale is able to operate as disclosed herein. For example, such scale features may be expressed and/or marked to be in a cartesian coordinate system on that reference scale, or in a polar coordinate system, or any other convenient coordinate system. Furthermore, such features may comprise features distributed evenly or unevenly throughout an operational scale area, and may comprise graduated or ungraduated scale markings, provided that such features correspond to known dimensional coordinates on the scale and are able to operate as disclosed herein.

It will be understood that although the robot systems and corresponding movable arm configurations disclosed and illustrated herein are generally shown and described with reference to a certain number of arm portions (e.g., 3 arm portions, etc.), such systems are not so limited. In various implementations, provided that it includes arm portions such as those described herein, the robot system may include fewer or more arm portions if desired.

It will be understood that as described herein a scale and a camera that is used to image the scale may undergo rotation relative to one another, depending on the motion and/or position of the robot system. It will be appreciated that methods known in the art (e.g. as disclosed in the incorporated references) may be used to accurately determine any such relative rotation and/or perform any required coordinate transformations, and/or analyze the relative position of the camera and the scale according to principles disclosed herein, in regard to such relative rotations. It will be understood that the metrology position coordinates referred to herein may in various implementations take into account any such relative rotation. Furthermore, it will be understood that in some implementations the metrology position coordinates referred to herein comprise a set of coordinates that include a precise determination and/or indication of any such relative rotation.

While preferred implementations of the present disclosure have been illustrated and described, numerous variations in the illustrated and described arrangements of features and sequences of operations will be apparent to one skilled in the art based on this disclosure. Various alternative forms may be used to implement the principles disclosed herein. In addition, the various implementations described above can be combined to provide further implementations. All of the U.S. patents and U.S. patent applications referred to in this specification are incorporated herein by reference, in their entirety. Aspects of the implementations can be modified, if necessary to employ concepts of the various patents and applications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled.

1. A robot system, comprising:
a robot, comprising:
a movable arm configuration, comprising:
a first arm portion mounted to a first rotary joint at a proximal end of the first arm portion, the first rotary joint having a first rotary axis, wherein the first arm portion has a second rotary joint located at a distal end of the first arm portion, the second rotary joint having a second rotary axis;
a second arm portion mounted to the second rotary joint at a proximal end of the second arm portion, such that the second arm portion rotates about the second rotary joint; and
an end tool mounting configuration for mounting an end tool, wherein the end tool mounting configuration is located proximate to a distal end of the movable arm configuration; and
a motion control system configured to control an end tool position of the end tool with a level of accuracy defined as a robot accuracy, based at least in part on sensing and controlling the angular positions of the first and second arm portions about the first and second rotary joints, respectively, using rotary sensors included in the robot; and
a supplementary metrology position determination system, comprising:
a metrology processing portion;
first and second scales that are on the movable arm configuration, each scale comprising a plurality of respective imageable features;
a first camera configured to acquire an image of the first scale at an image acquisition time, wherein the first camera is coupled to the first arm portion such that the first camera is configured to rotate around the first scale and a field of view of the first camera is configured to move along a first rotary measurement axis direction on the first scale as the first arm portion is rotated around the first rotary joint, and for which a bending of the first arm portion causes a movement of the field of view of the first camera along a direction that is transverse to the first rotary measurement axis direction on the first scale; and
a second camera configured to acquire an image of the second scale at an image acquisition time, wherein the second camera is coupled to the second arm portion such that the second camera is configured to rotate around the second scale and a field of view of the second camera is configured to move along a second rotary measurement axis direction on the second scale as the second arm portion is rotated around the second rotary joint, and for which a bending of the second arm portion causes a movement of the field of view of the second camera along a direction that is transverse to the second rotary measurement axis direction on the second scale.

2. The robot system of claim 1, wherein the metrology processing portion is configured to:
determine a first angular orientation of the first arm portion based at least in part on a first image of the first scale as acquired by the first camera at a first image acquisition time; and
determine a first angular orientation of the second arm portion based at least in part on a first image of the second scale as acquired by the second camera at the first image acquisition time.

3. The robot system of claim 2, wherein:
a rotation of the first arm portion causes a rotation of the field of view of the first camera; and
a rotation of the second arm portion causes a rotation of the field of view of the second camera.

4. The robot system of claim 3, wherein the metrology processing portion is further configured to determine at least one of:
a bending amount of the first arm portion based at least in part on the first image of the first scale as acquired by the first camera at the first image acquisition time;
a bending amount of the second arm portion based at least in part on the first image of the second scale as acquired by the second camera at the first image acquisition time;
a twisting amount of the first arm portion based at least in part on the first image of the first scale as acquired by the first camera at the first image acquisition time; or
a twisting amount of the second arm portion based at least in part on the first image of the second scale as acquired by the second camera at the first image acquisition time.

5. The robot system of claim 2, wherein the metrology processing portion is further configured to determine metrology position coordinates of the end tool position at the first image acquisition time based at least in part on the determined first angular orientations of the first and second arm portions.

6. The robot system of claim 2, wherein the metrology processing portion is further configured to:
determine a second angular orientation of the first arm portion based at least in part on a second image of the first scale as acquired by the first camera at a second image acquisition time; and
determine a second angular orientation of the second arm portion based at least in part on a second image of the second scale as acquired by the second camera at the second image acquisition time.

7. The robot system of claim 6, wherein the metrology processing portion is further configured to:
determine metrology position coordinates of a first end tool position at the first image acquisition time based at least in part on the determined first angular orientations of the first and second arm portions;
determine metrology position coordinates of a second end tool position at the second image acquisition time based at least in part on the determined second angular orientations of the first and second arm portions; and
utilize the determined metrology position coordinates of the first and second end tool positions to determine a dimension that is related to a distance between the first and second end tool positions.

8. The robot system of claim 7, wherein the dimension is a distance between first and second surface locations on a workpiece, and a contact point of the end tool contacts the first surface location on the workpiece at the first image acquisition time and contacts the second surface location on the workpiece at the second image acquisition time.

9. The robot system of claim 8, wherein the end tool is at least one of a touch probe or a scanning probe that is used for measuring the workpiece.

10. The robot system of claim 1, wherein the first and second scales are curved.

11. The robot system of claim 1, wherein the first scale is on a supporting base portion of the movable arm configuration.

12. The robot system of claim 1, wherein the first scale is curved around at least part of a supporting base portion of the movable arm configuration.

13. The robot system of claim 12, wherein the second scale is curved around at least part of the distal end of the first arm portion.

14. A method for operating a supplementary metrology position determination system that is utilized with a robot,
the robot comprising:
a movable arm configuration, comprising:
a first arm portion mounted to a first rotary joint at a proximal end of the first arm portion, the first rotary joint having a first rotary axis, wherein the first arm portion has a second rotary joint located at a distal end of the first arm portion, the second rotary joint having a second rotary axis;
a second arm portion mounted to the second rotary joint at a proximal end of the second arm portion, such that the second arm portion rotates about the second rotary joint; and
an end tool mounting configuration for mounting an end tool, wherein the end tool mounting configuration is located proximate to a distal end of the movable arm configuration; and
a motion control system configured to control an end tool position of the end tool with a level of accuracy defined as a robot accuracy, based at least in part on sensing and controlling the angular positions of the first and second arm portions about the first and second rotary joints, respectively, using rotary sensors included in the robot; and
the supplementary metrology position determination system comprising:
first and second scales that are on the movable arm configuration, each scale comprising a plurality of respective imageable features; and
first and second cameras; and
the method comprising:
operating the first camera to acquire a first image of the first scale at a first image acquisition time, wherein the first camera is coupled to the first arm portion such that the first camera rotates around the first scale and a field of view of the first camera moves along a first rotary measurement axis direction on the first scale as the first arm portion is rotated around the first rotary joint, and for which a bending of the first arm portion causes a movement of the field of view of the first camera along a direction that is transverse to the first rotary measurement axis direction on the first scale; and
operating the second camera to acquire a first image of the second scale at the first image acquisition time, wherein the second camera is coupled to the second arm portion such that the second camera rotates around the second scale and a field of view of the second camera moves along a second rotary measurement axis direction on the second scale as the second arm portion is rotated around the second rotary joint, and for which a bending of the second arm portion causes a movement of the field of view of the second camera along a direction that is transverse to the second rotary measurement axis direction on the second scale.

15. The method of claim 14, further comprising:
determining a first angular orientation of the first arm portion based at least in part on the first image of the first scale as acquired by the first camera at a first image acquisition time; and
determining a first angular orientation of the second arm portion based at least in part on the first image of the second scale as acquired by the second camera at the first image acquisition time.

16. The method of claim 15, further comprising determining at least one of:
a bending amount of the first arm portion based at least in part on the first image of the first scale as acquired by the first camera at the first image acquisition time;
a bending amount of the second arm portion based at least in part on the first image of the second scale as acquired by the second camera at the first image acquisition time;
a twisting amount of the first arm portion based at least in part on the first image of the first scale as acquired by the first camera at the first image acquisition time; or
a twisting amount of the second arm portion based at least in part on the first image of the second scale as acquired by the second camera at the first image acquisition time.

17. The method of claim 15, further comprising determining metrology position coordinates of the end tool position at the first image acquisition time based at least in part on the determined first angular orientations of the first and second arm portions.

18. The method of claim 15, further comprising:
operating the first camera to acquire a second image of the first scale at a second image acquisition time;
operating the second camera to acquire a second image of the second scale at the second image acquisition time;
determining a second angular orientation of the first arm portion based at least in part on the second image of the first scale as acquired by the first camera at the second image acquisition time; and
determining a second angular orientation of the second arm portion based at least in part on the second image of the second scale as acquired by the second camera at the second image acquisition time.

19. The method of claim 18, further comprising:
determining metrology position coordinates of a first end tool position at the first image acquisition time based at least in part on the determined first angular orientations of the first and second arm portions;
determining metrology position coordinates of a second end tool position at the second image acquisition time based at least in part on the determined second angular orientations of the first and second arm portions; and
utilizing the determined metrology position coordinates of the first and second end tool positions to determine a dimension that is related to a distance between the first and second end tool positions.

20. A supplementary metrology position determination system for use with a robot that comprises a movable arm configuration with first and second arm portions, first and second rotary joints, and an end tool mounting configuration for mounting an end tool, and a motion control system configured to control an end tool position of the end tool, the supplementary metrology position determination system comprising:
a metrology processing portion;
first and second scales that are on the movable arm configuration, each scale comprising a plurality of respective imageable features;
a first camera configured to acquire an image of the first scale at an image acquisition time, wherein the first camera is coupled to the first arm portion such that the first camera is configured to rotate around the first scale and a field of view of the first camera is configured to move along a first rotary measurement axis direction on the first scale as the first arm portion is rotated around the first rotary joint, and for which a bending of the first arm portion causes a movement of the field of view of the first camera along a direction that is transverse to the first rotary measurement axis direction on the first scale; and
a second camera configured to acquire an image of the second scale at an image acquisition time, wherein the second camera is coupled to the second arm portion such that the second camera is configured to rotate around the second scale and a field of view of the second camera is configured to move along a second rotary measurement axis direction on the second scale as the second arm portion is rotated around the second rotary joint, and for which a bending of the second arm portion causes a movement of the field of view of the second camera along a direction that is transverse to the second rotary measurement axis direction on the second scale.
